(19) United States
(12) Patent Application Publication
(10) Pub. No.: US 2005/0125158 A1
(43) Pub. Date: Jun. 9, 2005

(54) Generating a mathematical model for diabetes

(75) Inventors: Leonard Schlessinger, Pacific Palisades, CA (US); David Eddy, Aspen, CO (US)

Correspondence Address: Robert A. Saltzberg;Morrison & Foerster LLP, 425 Market Street, San Francisco, CA, 94105, US

(73) Assignee: Kaiser Foundation Health Plan Inc.

(21) Appl. No.: 10/763,653

(22) Filed: Jan. 22, 2004

Related U.S. Application Data
(63) Continuation-in-part of application No. 10/668,509, filed on Sep. 22, 2003, now abandoned.
Application No. 10/668,509 is a continuation-in-part of application No. 10/025,964, filed on Dec. 19, 2001.

(51) Int. Cl. G06G 7/48; G06G 7/58

(52) U.S. Cl. 702/19; 600/300

(57) ABSTRACT

A mathematical model specifically for diabetes may be generated which may be continuous in time, in that there are no discrete time steps, and any event can occur at any times. The model may be generated using differential equations, object oriented programming, and features. The model may be used to simulate patients who have contracted or may contract type 1 or type 2 diabetes, which greatly improves the efficiency of treating patients and designing clinical trials.

### STATEMENT OF RELATED APPLICATIONS

This application is a continuation-in-part of co-pending patent application Ser. No. 10/668,509, entitled “GENERATING A MATHEMATICAL MODEL FOR DIABETES”, by Leonard Schlessinger and David Eddy, filed on Sep. 22, 2003, which is a continuation-in-part of patent application Ser. No. 10/025,964, entitled “GENERATION OF CONTINUOUS MATHEMATICAL MODEL FOR COMMON FEATURES OF A SUBJECT GROUP”, by Leonard Schlessinger and David Eddy, filed on Dec. 19, 2001.

### FIELD OF THE INVENTION

The present invention relates to the generation of mathematical models. More particularly, the present invention relates to the generation of a mathematical model for diabetes.

### BACKGROUND OF THE INVENTION

Mathematical modeling is well known in the art. Presently, mathematical models are in widespread use in nearly all forms of technologies such as in computer hardware and software and as an aide in the optimizing and improving of practically every development and manufacturing effort. As a result, mathematical models play an integral role in most technologies in use today.

These mathematical models have been developed and applied to a wide variety of technologies depending upon the intended need at the implementation site. One useful application of mathematical models today is in the field of health care. Delivering high quality health care efficiently generally requires making a large number of decisions as to which treatments to administer to which patients at what times and using what processes. While every conceivable alternative may be tried in an experimental setting to empirically determine the best possible approach, as a practical matter such a scenario is often impossible to carry out. Prohibitive factors such as the large number and combinations of interventions, the required long follow up times, the difficulty of collecting data and of getting patients and practitioners to comply with experimental designs, and the financial costs of the experiment, among other factors, all contribute to render an experimental approach impractical. Therefore it is highly desirable to use mathematical models in the development and implementations of high quality health care.

While offering a significant advantage over the experimental approach, the current usage of mathematical models in health care is not without shortcomings. Presently, mathematical models are generally used to address very narrow questions, such as the frequency of a particular screening test. More importantly, these models are discrete in scope and lack inclusion of any time factor at all, or include only one time period or a series of fixed time periods. In addition, these models generally do not include intervention factors or events that occur in the intervals between the fixed periods of other models, nor do they incorporate the dependencies between various parameters of the model, such as dependencies between biological features of a subject and its disease afflictions.

Diabetes is a disorder of carbohydrate metabolism, usually occurring in genetically predisposed individuals, characterized by inadequate production or utilization of insulin and resulting in excessive amounts of glucose in the blood and urine, excessive thirst, weight loss, and in some cases progressive destruction of small blood vessels leading to such complications as infections and gangrene of the limbs or blindness.

Type 1 diabetes is a severe form in which insulin production by the beta cells of the pancreas is impaired, usually resulting in dependence on externally administered insulin, the onset of the disease typically occurring before the age of 25. Type 2 diabetes is a mild, sometime asymptomatic form characterized by diminished tissue sensitivity to insulin and sometimes by impaired beta cell function, exacerbated by obesity and often treatable by diet and exercise.

Models have been created in the past in an attempt to simulate the course of diabetes in patients. However, these models have been extremely limited. They typically split time into intervals, and only measure or report findings at discrete time periods (e.g., once a month). Factors are split into crude states (such as dead vs. alive, or coronary artery disease vs. no coronary artery disease). These states may only change at the discrete time periods.

Furthermore, these models are based on statistical analyses of reported patient data, and not on actual human physiology. Thus, not only are these models typically inadequate, they cannot even be validated before or even during their use. They must wait until after the patient's disease has run its course. Diabetes, however, is a chronic disease. Additionally, significant amounts of money are spent on clinical trials to test new drugs, procedures, etc. on patients. Validating a model's accuracy before the trial begins can save money, and perhaps patients' lives, by allowing the researchers to modify the clinical trial before it starts.

Thus, what is needed is a mechanism for modeling diabetes that is continuous in time. What is also needed is a mechanism for modeling diabetes that may be validated using physiology.

### BRIEF DESCRIPTION

A mathematical model specifically for diabetes may be generated which may be continuous in time, in that there are no discrete time steps, and any event can occur at any times. The model may be generated using differential equations, object oriented programming, and features. The model may be used to simulate patients who have contracted or may contract type 1 or type 2 diabetes, which greatly improves the efficiency of treating patients and designing clinical trials.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating a method for generating a continuous mathematical model of a feature such as blood pressure in a group of humans in accordance with an embodiment of the present invention.

FIG. 2 is a diagram illustrating the various trajectories of a feature, such as blood pressure, common to real subjects in a subject group in a sample space in accordance with an embodiment of the present invention.

FIGS. 3-9A respectively are diagrams illustrating the samples of the distribution for each of the seven fⱼ, f₀ to f₆ histogrammatically.

FIGS. 9A-9B respectively are diagrams illustrating samples for the distribution for the random variables s₀ and s₁.

FIG. 10 is a flow diagram illustrating the resolution of dependencies of the selected parameters fⱼ(ω) prior to generating the continuous mathematical model in accordance with an embodiment of the present invention.

FIG. 11 is a diagram illustrating an embodiment of the present invention where the mathematical model can be used for multiple features common to a subject group, and for generating trajectories that represent the interdependence of these common features.

FIG. 12 is a diagram illustrating the variables pertinent to the development and progression of diabetes, and their relationships.

FIG. 13 is a flow diagram illustrating a method for estimating a virtual patient's fasting plasma glucose (FPG) level in accordance with an embodiment of the present invention.

FIG. 14 is a flow diagram illustrating a method for estimating if a virtual patient has developed symptoms of type 1 diabetes in accordance with an embodiment of the present invention.

FIG. 15 is a flow diagram illustrating a method for estimating if a virtual patient has developed symptoms of type 2 diabetes in accordance with an embodiment of the present invention.

FIG. 16 is a flow diagram illustrating a method for estimating a virtual patient's hemoglobin A_{1c}(HbA_{1c}) in accordance with an embodiment of the present invention.

FIG. 17 is a flow diagram illustrating a method for estimating a virtual patient's randomly measured blood glucose (RPG) in accordance with an embodiment of the present invention.

FIG. 18 is a flow diagram illustrating a method for estimating a virtual patient's tolerance to an oral glucose load at age t in accordance with an embodiment of the present invention.

FIG. 19 is a flow diagram illustrating a method for estimating a virtual patient's thirst level at time x in accordance with an embodiment of the present invention.

FIG. 20 is a flow diagram illustrating a method for estimating the probability of occurrence of diabetic ketoacidosis events (DKAₜᵢₘₑ) for a virtual patient in accordance with an embodiment of the present invention.

FIG. 21 is a flow diagram illustrating a method for estimating the probability of a moderate or severe hypoglycemic event (HypoGlyRate) in a virtual patient in accordance with an embodiment of the present invention.

FIG. 22 is a block diagram illustrating an apparatus for estimating a virtual patient's fasting plasma glucose (FPG) level in accordance with an embodiment of the present invention.

FIG. 23 is a block diagram illustrating an apparatus for estimating if a virtual patient has developed symptoms of type 1 diabetes in accordance with an embodiment of the present invention.

FIG. 24 is a block diagram illustrating an apparatus for estimating if a virtual patient has developed symptoms of type 2 diabetes in accordance with an embodiment of the present invention.

FIG. 25 is a block diagram illustrating an apparatus for estimating a virtual patient's hemoglobin A_{1c}(HbA_{1c}) in accordance with an embodiment of the present invention.

FIG. 26 is a block diagram illustrating an apparatus for estimating a virtual patient's randomly measured blood glucose (RPG) in accordance with an embodiment of the present invention.

FIG. 27 is a block diagram illustrating an apparatus for estimating a virtual patient's tolerance to an oral glucose load at age t in accordance with an embodiment of the present invention.

FIG. 28 is a block diagram illustrating an apparatus for estimating a virtual patient's thirst level at time x in accordance with an embodiment of the present invention.

FIG. 29 is a block diagram illustrating an apparatus for estimating the probability of occurrence of diabetic ketoacidosis events (DKAₜᵢₘₑ) for a virtual patient in accordance with an embodiment of the present invention.

FIG. 30 is a block diagram illustrating an apparatus for estimating the probability of a moderate or severe hypoglycemic event (HypoGlyRate) in a virtual patient in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In an embodiment of the present invention, an object-oriented approach to mathematical modeling may be utilized with differential equations and a concept known as “features” to build models that are continuous-time, continuous-variable, and physiology-based. The model may have three main parts: a model of human anatomy and physiology, a set of models that describe the processes of care (e.g., protocols, guidelines, provider decisions, and behaviors), and models of system resources (e.g., facilities, personnel, equipment, supplies, and costs). The model of human anatomy and physiology may determine the occurrence, progression, and interactions of diseases, the occurrence of signs and symptoms, the results of tests, the effects of treatments, and the ultimate health outcomes.

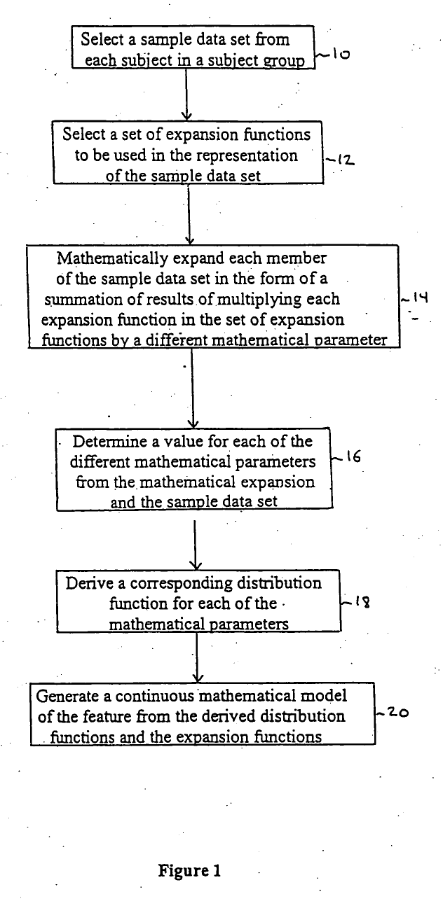

The present invention is directed to generating a continuous mathematical model of a feature common to subjects in a subject group. The model may then be used to create virtual patients. FIG. 1 is a flow diagram illustrating a method for generating a continuous mathematical model of a feature such as blood pressure in a group of humans in accordance with an embodiment of the present invention. The process starts at 10 where a sample data set from each subject in the subject group is selected. Next, at 12, a set of expansion functions to be used in the representation of the sample data set is also selected. At 14, the selections made in 10 and 12 are used to mathematically expand each member of the sample data set in the form of a summation of the results of multiplying each of the expansion functions in the set of expansion functions by a different mathematical parameter. Next, at 16, a value for each of the different mathematical parameters is determined from the mathematical expansion of 14, and the sample data set for each subject in the subject group. Next, at 18, a corresponding distribution function for each of the mathematical parameters is derived based on the values determined in 16. Finally, at 20, a continuous mathematical model of the feature is generated from the derived distribution functions of 18 and the expansion functions of 12. The details and purpose of operations performed in FIG. 1 will be described in more detail below.

Generally, mathematical simulation models are distinguished from other types of conceptual models by their inclusion of simulated objects, such as subjects, that correspond to real objects on a one-to-one basis. These simulations vary greatly in their scope such as in breadth, depth, and realism, and therefore require a very broad, deep and realistic model that could be used to address the full range of pertinent issues, such as clinical, administrative, and financial decisions in the health care context, at the level of detail at which real decisions can be made. Development of such a model requires creating a population of simulated individuals who experience all of the important events that occur in real subjects, and who respond to interventions in the same way as real subjects. In health care, for example, such developments require modeling the essential aspects of human anatomy, physiology, pathology, and response to medical treatment. Because timing is also an essential element of the occurrence, manifestation, progression, management, and outcome of disease, the model must also be continuous, rather than discontinuous.

To better demonstrate the various features and aspects of the present invention, a health-based model is consistently used throughout the specification as an exemplary environment. It should be noted however, that the invention disclosed herein is not limited to health care and its formulation and equations are general and can be applied to virtually any environment involving humans or non-humans, living or mechanical systems and the like. For example, this approach could be used to model animal or plant responses, or even complex mechanical, electromechanical or electronic systems.

In a health care environment, the physiology of a subject is characterized by “features,” which correspond to a wide variety of anatomic and biologic variables. Examples of features which may be modeled include, but are not limited to: blood pressure, cholesterol levels (i.e., high-density lipoprotein [HDL] and low-density lipoprotein [LDL]), bone mineral density, patency of a coronary artery, electrical potentials of the heart (as recorded on an electrocardiogram), contractility of myocardium, cardiac output, visual acuity, and serum potassium level. A feature can be continuously observable (e.g., a rash), intermittently observable through tests (e.g., diameter of a coronary artery), or not directly observable except through resultant events (e.g, “spread” of a cancer).

The “trajectory” of a feature, defined as the changes in a feature over time, in a particular subject can be affected by the subject's characteristics, behaviors and other features, often called “risk factors.” For example, the occlusion of a coronary artery can be affected by an individual's family history (genetics), sex, age, use of tobacco, blood pressure, LDL cholesterol level, and many other risk factors. If no interventions are applied to change it, the trajectory of a feature is called its “natural trajectory” or, in the medical vernacular, its “natural history.”

A “disease” is generally defined as an occurrence when one or more features are considered “abnormal”, however, because concepts of abnormality can change, definitions of diseases can change. Furthermore many definitions of diseases are “man made” and gross simplifications of the underlying physiology, and many diseases have different definitions put forth by different experts. For these reasons, it is important to model the underlying features rather than whatever definition of a disease is current. Additionally, because the definition of a disease often omits important behaviors and risk factors, it is sometimes more appropriate to think more broadly of “health conditions.”

For many diseases, there are “health interventions” which can change the value of one or more features, the rate of progression of one or more features, or both value and rate of progression. Interventions may affect features either indirectly (by changing risk factors, e.g., smoking) or directly (by changing the feature itself). Health interventions which have direct effects can change either the value of a feature (e.g., performing bypass surgery to open an occluded coronary artery) or the rate of change of a feature (e.g., lowering cholesterol to slow the rate of occlusion).

Accuracy is also a critical feature of any model. For models to be considered sufficiently accurate to be applied in the decision making process, the models must meet the following criteria. First, they must cause the events in the simulated population to statistically match the events observed in a real population. Second, they must cause the effects of treatment in the simulated population to statistically match the effects seen in real populations. This statistical matching arises because of the type of data available. In some cases, there are person-specific data on the values of a feature and the events it causes. In such cases, the models need to be able to reproduce those data for every individual, every value of the feature, and every event observed. In other cases, the data are aggregated across the population and are statistical in nature. For example, there may be data on the age specific incidence rates of breast cancer in a population, or the distribution of ages at which heart attack occurs in a population.

In these cases, as described above, statistical matching mandates that the statistics that describe the occurrence of events in the simulated population must match the statistics that describe the occurrence of events in the real population for every event observed. For example, the age specific incidence rates of breast cancer in the simulated population must be the same as in the real population, and both mean and variance of age distribution at which heart attacks occur in the simulated population must be the same as in the real population. Similarly, if a clinical trial of a treatment in a real population showed a particular effect on the occurrence of certain outcomes after a certain number of years, “statistical matching” would require that when the same treatment is given to a simulated population that is constructed to have the same characteristics as the real population, it must show the same effects on the outcomes after the same length of follow up.

The accuracy of a statistical match depends on the size of the simulated population. Since, as in real trials, simulated trials are affected by sample size, statistical matching requires that simulated results match real results within appropriate confidence intervals, and that as the size of the simulation increases the simulated results will converge on the real results.

Features that define important diseases can also be represented by statistical models. These models for the features depend on the number of features, the number of events and the available data. In its simplest form, the model is of a single feature of a person, and there are person specific data available on the values of the feature at a series of times. For example, if a selected organ is the heart, then a part of the organ is a coronary artery, the feature can be the degree of occlusion of the artery, and an event associated with the feature can be a heart attack.

For each subject it is desirable to define a function that describes the natural progression or trajectory of the feature over time, such as from birth to death, where “natural” means the trajectory of the feature in the absence of any special interventions from the health care system. Other equations can then be used to simulate the effects of interventions.

For example, if a particular subject is indexed by k, then the trajectory of a particular feature for the k^{th} subject can be modeled F^{k}((t), where t is the time since the subject's birth (age). Because interventions can change either the value of a feature or the rate of change of a feature, a differential equation is used for F^{k}(t). The general form of the differential equation for each subject is

$$\frac{ⅆ {F}^{k} ( t )}{ⅆ t} = {R}^{k} ( t ) ,$$

where F^{k}(t) is the value of the feature at time t for the k^{th} subject, and R^{k} (t) is the rate at which the value of the feature is changing at time t (the derivative). Either F^{k}(t) or R^{k}(t) determines the natural trajectory for the k^{th} subject, and either F^{k}(t) or R^{k}(t) can be determined from the other. For simplicity of description, the focus is on the value of the feature, F^{k}(t), with the understanding that the rate of change of the feature, R^{k}(t), can always be derived from F^{k}(t) using this equation.

In accordance with the present invention, a set of trajectories are created for a population of simulated subjects. The created trajectories are designed to statistically match the trajectories of a population of real subjects. As shown in FIG. 1, at first, at 10, a sample data set from each subject in the subject group is selected.

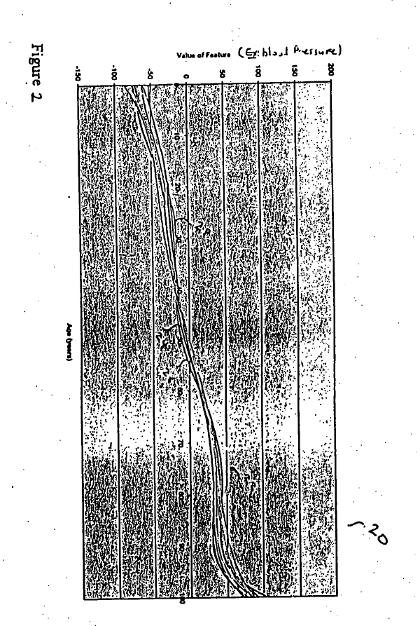

FIG. 2 is a diagram illustrating the various trajectories of a feature, such as blood pressure, common to real subjects in a subject group in a sample space in accordance with an embodiment of the present invention. For simplicity, the trajectories for only four subjects 22, 24, 26 and 28 are enumerated herein, although any number of real subjects can be used. Each trajectory on the sample space 20 represents a sample data set on the same feature of each subject, such as the subject's blood pressure level, at a specific age. Additionally, the trajectories of real subjects are considered a random (stochastic) process parameterized by age, although as described below, the random process can be conditional on risk factors and other features. The sample space 20 for a particular feature is the collection of the one trajectory for each person. For simplicity, the sample space 20 is mathematically denoted as “Ω” throughout the equations in the specifications, with elements ω=(ω₁,ω₂,ω₃ . . . ), where ωₖ specifies the trajectory of the feature of a particular person, such as trajectory 22 in FIG. 2. The random process for the trajectories is designated by upper case letters set in boldface font and is notated as having explicit dependence on ω, that is, F(ω,t). Each function in equation (1) is a realization of the stochastic process insofar as F^{k}(t)=F(ωₖ,t), where ωₖ is the trajectory of the k^{th} person in the set ω.

Returning to FIG. 1, at 12 a set of expansion functions are selected. As described below and in greater detail, these expansion functions are used in the representation of the sample data sets.

Next, at 14, the selections made at 10 and 12 are used to mathematically expand each member of the sample data set in the form of a summation of the results of multiplying each of the expansion functions in the set of expansion functions by a different mathematical parameter, such as the weighted coefficients. In an exemplary embodiment, the total number of parameters cannot exceed the total number of sample data points used in a subject data set. In its simplest form, only one parameter is used. Next, at 16, a mathematical expansion is performed on the selected data sets to determine the values for each selected parameter. There are many ways well known to those skilled in the art to estimate the specific values for the mathematical parameters, depending on how the expansion functions are chosen. In an exemplary embodiment, the method used is one that is guaranteed to mathematically converge, such as a Fourier expansion.

Using a Fourier expansion involves expanding F(ω,t) (or any function of F(ω,t), such as the log of the odds ratio of F (ω, t), a logit transform) in a Fourier-type series. Each term of the series includes two parts: an age dependent, deterministic (nonrandom) “basis” expansion function (denoted as Pⱼ(t) for the j^{th} term in the expansion), multiplied by a mathematical parameter, also called a coefficient, (denoted by a lower case letter) which is an age independent random variable, fⱼ(ω). The basis functions Pⱼ(t) could be any set of functions. Some examples include: a polynomial series, i.e., t^{j}, the j^{th} Legendre or Laguerre polynomial, or a Fourier series, i.e., sin(jt/T).

When the basis functions are chosen to be orthonormal over the range of ages of interest, then the expansion is called a Karhunen-Loeve (K-L) decomposition. Because the theory of K-L decompositions is reasonably well developed and because the K-L decomposition has several well known advantages, there are good reasons to choose the Pⱼ(t) to be orthonormal. The Legendre, Laguerre, and Fourier functions are examples of such orthonormal functions.

Whichever basis function is chosen, it is to be the same for every subject in the model. The coefficients fⱼ(ω), however, are random variables and are to be different for each subject. Choice of basis functions thus affects the coefficients calculated and the rate of convergence for the series (i.e., number of terms needed to fit the data) but will not prevent the method from working.

Thus, in general, the mathematical expansion will have the form of:

$$F ( ω , t ) = {\sum }_{j = 0}^{∞} {f}_{j} ( ω ) {P}_{j} ( t )$$

Samples of the distributions for the coefficients fⱼ(ω) are now estimated. In practice, the summation in this equation is truncated to a finite number of terms, J+1. This number is related to (but not greater than) the number of events observed for each subject. The method for estimating the fⱼ(ω) depends on the available data. In a desirable case, there are subject specific data that provide a series of values of the feature at specified times for a large number of subjects. For example, there might be a series of measurements of intraocular pressures for a group of subjects. In addition there is no requirement that the measurements for each person be taken at the same times.

The function describing the trajectory for the k^{th} real person is approximated by a finite sum,

$${F}^{k} ( t ) \approx {\sum }_{j = 0}^{J} {f}_{j}^{k} {P}_{j} ( t ) ,$$

where fⱼ^{k} are the coefficients determined to fit the data observed for the subject. The fⱼ^{k} coefficients are the samples that will be used to estimate the distribution of the coefficients fⱼ(ω). There are many different ways that can be used to estimate the fⱼ^{k} from the data, and for simplicity only three methods are described herein: (a) the method requiring the expansion through all of the observed points, (b) the method of least squares, and (c) the method using the orthonormal properties of Pⱼ(t).

Using the first method envisions that for each person there are J+1 observations. This will lead to J+1 equations with J+1 unknowns. This linear system of equations can be solved for the fⱼ^{k} coefficients using standard methods.

The second method of determining the fⱼ^{k} coefficients is by least squares. This method is most desirable to use when the number of terms is less than the number of observations for each person. For example, if there are M observations that can be used to determine coefficients for the J+1 terms, where J<M, the fⱼ^{k} coefficients can be determined by minimizing the sum of the squares of the differences between the value of the function and the value of the expansion on the right hand side of the equation at all of the M points. The expression to be minimized for this method is

$${\sum }_{m = 1}^{m = M} {( {F}^{k} ( {t}_{m} ) - {\sum }_{j = 0}^{j = J} {f}_{j}^{k} {P}_{j} ( {t}_{m} ) )}^{2} .$$

Taking the derivative of this equation with respect to each fⱼ^{k} (j=0 to J) and setting this derivative to zero produces a set of linear equations which determine the fⱼ^{k}.

The third way to determine the fⱼ^{k} makes use of the orthonormal properties of the Pⱼ(t). Multiplying both sides of the equation by Pⱼ(t)*W(t) (where W(t) is the weight for that orthonormal function) and using the orthogonality property, directly yields the following expression for fⱼ^{k}:
fⱼ^{k}=∫F^{k}(t)*Pⱼ(t)*W(t)dt

The observed points are used to approximate the integral. As before, there must be at least J+1 observations. The coefficients determined in this way will minimize the integral of the square of the difference between the right and left sides of the equation. That is, the coefficients will minimize

$$\int ⅆ {t ( {F}^{k} ( t ) - {\sum }_{j = 0}^{j = J} {f}_{j}^{k} {P}_{j} ( t ) )}^{2} W ( t ) .$$

The underlying theory for this type of expansion are well known functional analysis techniques. One advantage of using this method is that the power of the theory of functional analysis can be applied to the estimation procedure. Moreover, many properties of the K-L decomposition require the use of this type of expansion.

For any set of basis functions chosen initially, any of these three methods can be used to find values of the coefficients which cause each person's trajectory to fit the data.

In another embodiment of the present invention, Hybrid expansion is used at 14 of FIG. 1. The Hybrid expansion is more closely related to the familiar regression techniques used to analyze health data but unlike the Fourier expansion, the Hybrid expansion is not guaranteed to converge.

Hybrid expansion is employed in the cases where the use of a nonstandard functions may be helpful as part of the set of basis functions. For instance, when a feature may reasonably be believed to depend strongly on one or more other features, a natural tendency may be to try to incorporate that dependency explicitly into the basis functions. Specifically, for example, occlusion of the coronary artery (F₁) is known to depend on both blood pressure (F₂) and cholesterol level (F₃), among other things. These features can be included in the expansion for F₁ as follows:
(a) As described above for a Fourier expansion, the set of basis functions is Pⱼ(t). However, instead of choosing the Pⱼ(t) orthonormal, the P₀(t) represents blood pressure level for the subject, and P₁(t) represent total cholesterol level for that subject. Additional basis functions could be chosen to address dependencies or other relations between features. For example, P₂(t) can represents the product of blood pressure level and total cholesterol level and P₃(t) can represents the product of three values: t, blood pressure level, and cholesterol level. As in the Fourier expansion, the remaining basis functions would be the orthonormal set.
(b) After the first few basis functions are chosen to include other features, the remainder of the analysis can proceed as for the Fourier expansion except that the equation cannot be used to determine the coefficients (i.e., because the full set of basis functions is no longer orthonormal). The other equations will still apply however. For example, the covariance matrix can still be diagonalized to obtain a new set of basis functions having the desired properties. It should be noted, however, that the first few basis functions will be different for every subject because the functions describe the progression of a particular feature for a particular subject.

This type of Hybrid expansion is related to the expansions traditionally used in regression analyses. The independent variables in a regression equation correspond to the basis functions in the mathematical model of the present invention, and the coefficients also correspond to the coefficients used in the model of the present invention.

The hybrid method has several advantages: (a) it is intuitively appealing; (b) it corresponds to regression models, which are familiar; and (c) it can determine how important is the dependence of one feature on another (e.g., importance of blood pressure level in determining progression of coronary artery occlusion). Moreover, the hybrid method can converge even faster than can the conventional method.

After the determination of the values of the coefficients using a mathematical expansion is performed at 14 and 16 of FIG. 1, the flow proceeds to 18 where a probability distribution is generated from the determined values of the coefficients using various implementations of the well known Maximum Likelihood technique.

At this point new values for the trajectories can be generated by the continuous mathematical model to create new simulated subject which can be used to explore outcomes and effects of interventions in the new simulated group.

The following Example 1 is provided to further illustrate the above-described workings of the present invention:

FIG. 2 shows a set of trajectories selected from a large subject group. In this example, 123 trajectories are selected and though they are not all shown, they all adhere to the general form of those enumerated as 22, 24, 26 and 28. Each of these trajectories is one of the F^{k}((t) functions described above. Next, each trajectory is fitted into a series having the mathematical form of

$${F}^{k} ( t ) \approx {\sum }_{j = 0}^{J} {f}_{j}^{k} {P}_{j} ( t ) .$$

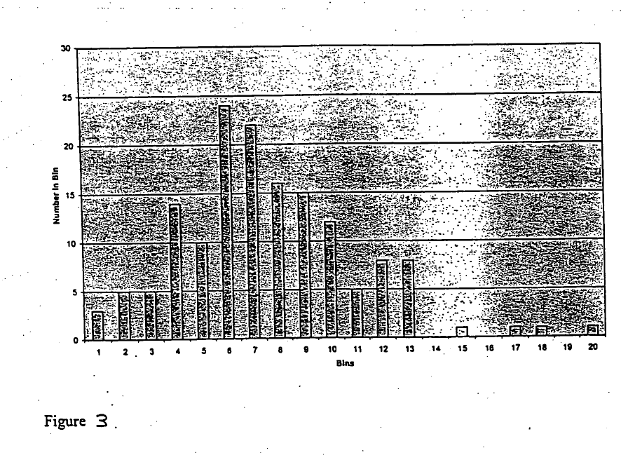

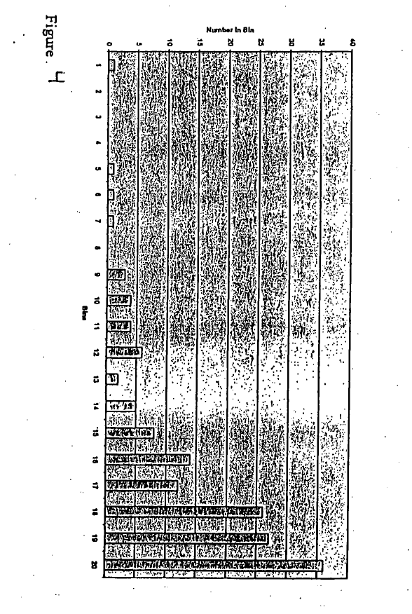

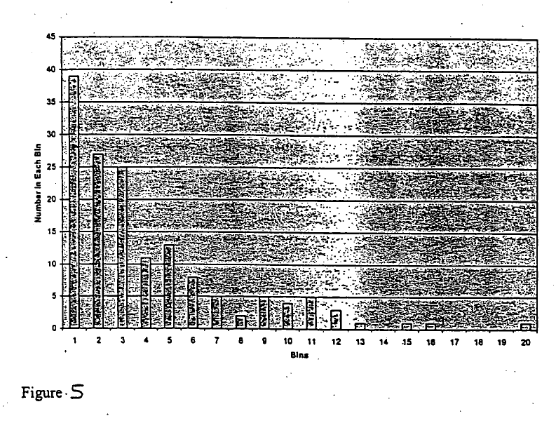

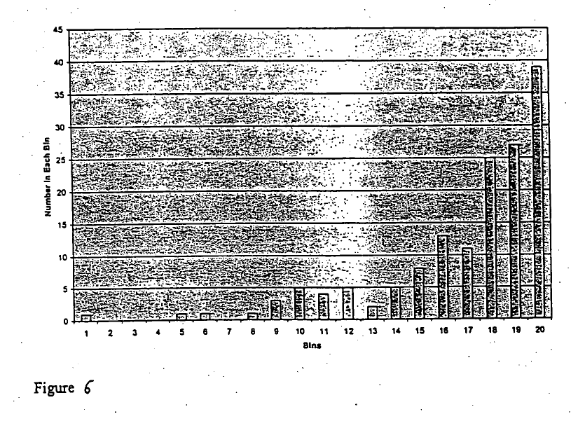

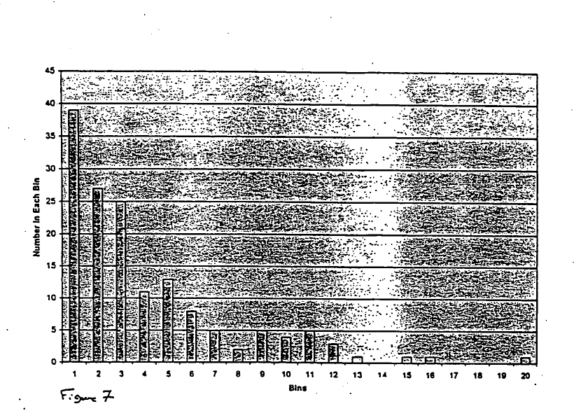

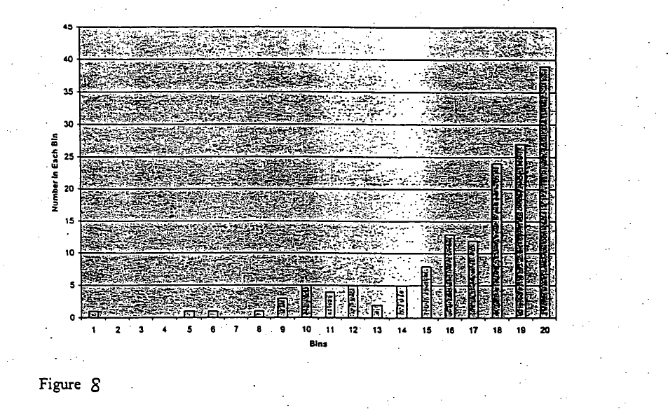

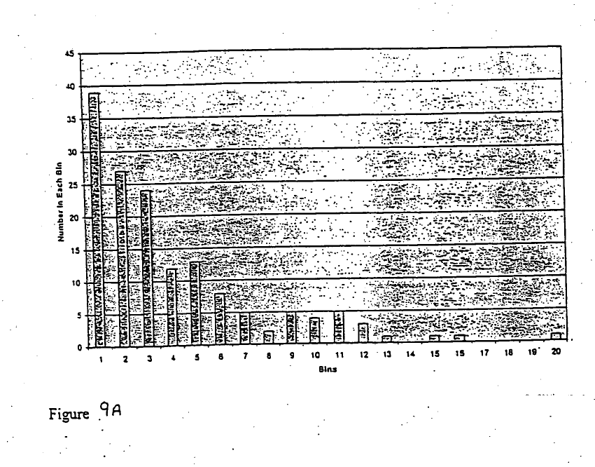

In this example, a function Pⱼ(t)=(t/50)^{j} is used as the expansion function and J is set to 6, both for illustrative purposes only. Thus, with J equal to 6, there are seven terms (0-6) in the series, resulting in a large set of fⱼ^{k}, as there are six Js for each value of k and there are 123 individuals or values of k in the sample. Thus, there are 123 values of fⱼ^{k} for each value of J. These values are the samples of fⱼ that are used to determine the distribution of each fⱼ. Using these samples, distribution of the fⱼ^{k} is obtained using various implementations of the well known Maximum Likelihood technique. The samples of the distribution for each of the seven fⱼ, f₀ to f₆ are shown histogrammatically in each of FIGS. 3-9A, respectively. FIGS. 3-9A, thus show the number of samples of fⱼ^{k} in each bin where each fⱼ with the following range (along the horizontal axis) is divided from the smallest to the largest value of the samples of fⱼ^{k} into 20 bins: f₀ ranges from −28.4 to 54.1, f₁ ranges from −1059.6 to 224.1, f₂ ranges from 1107.3 to 5278.1, f₃ ranges from 10555.7 to 2214.7, f₄ ranges from 2076 to 9895, f₅ ranges from −4353.9 to 913.6, and f₆ ranges from −152.3 to 725.6.

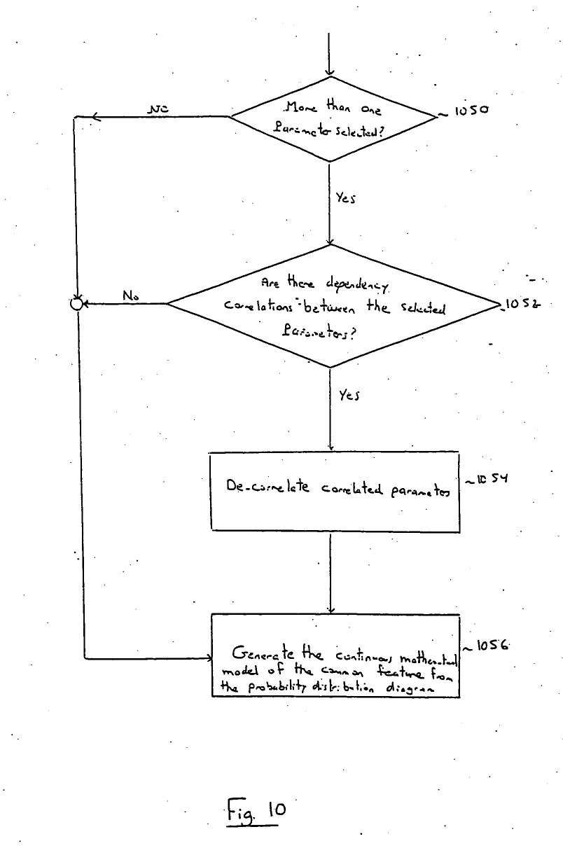

Other contingencies in generating the mathematical model of the present invention will now be discussed in greater detail. FIG. 10 is a flow diagram illustrating the resolution of dependencies of the selected parameters fⱼ(ω) prior to generating the continuous mathematical model. Generally, if fⱼ(ω) represent independent random variables, a particular subject could be created by drawing values for each of the j random variables fⱼ(ω) and then using the equations to calculate a particular simulated trajectory. As shown at 1050, if only one parameter is selected, the independence of the coefficients is automatically guaranteed and the flow proceeds to 1056 for generation of the continuous mathematical model of the common feature from the probability distribution diagram.

If more than one coefficient is selected, then the flow proceeds to 1052 where a determination is made as to the independence of the coefficients fⱼ(ω). If the fⱼ(ω) values are independent, then their covariance is zero. First, the distributions of each coefficient is transformed by subtracting out the mean of the individual values of the coefficient. For notational simplicity the mean of a coefficient is represented with angle brackets throughout the disclosure. Thus, for the j^{th} coefficient

$$〈 {f}_{j} 〉 = \frac{1}{K} {\sum }_{k = 1}^{K} {f}_{j}^{k}$$

where K is the total number of individuals for which data exist. Then for the k^{th} individual, subtracting out the means from the coefficients in the equations yields

$${F}^{k} ( t ) = ( {\sum }_{j = 0}^{J} ( {f}_{j}^{k} - 〈 {f}_{j} 〉 ) {P}_{j} ( t ) ) + ( {\sum }_{j = 0}^{J} 〈 {f}_{j} 〉 {P}_{j} ( t ) )$$

The coefficient of the first term on the right is the original coefficient with the mean subtracted out. The last term on the right is required to maintain the equation, and can be thought of as the average trajectory—the basis functions weighted by the average values of the coefficients, which can be represented as (F(t))—that is,

$$〈 F ( t ) 〉 = {\sum }_{j = 0}^{J} 〈 {f}_{j} 〉 {P}_{j} ( t )$$

Q may then represent the new coefficient; that is,
qⱼ^{k}=fⱼ^{k}−(fⱼ)

This results in a new equation for the trajectory of the feature. This yields:

$${F}^{k} ( t ) = {\sum }_{j = 0}^{J} {q}_{j}^{k} {P}_{j} ( t ) + 〈 F ( t ) 〉$$

Now the covariance matrix C with elements Cᵢⱼ is defined as

$${C}_{ij} = \frac{1}{K} {\sum }_{k = 1}^{K} {q}_{i}^{k} {q}_{j}^{k}$$

If the original coefficients fⱼ(ω) are independent, the off-diagonal terms of the covariance matrix will be zero. When the fⱼ(ω) values are independent, the flow proceeds to 1056 where the generation of the continuous mathematical model of the common feature from the probability distribution diagram is performed.

If the original coefficients are not independent (i.e., they are dependent), then the flow proceeds to 1054 where the coefficients are decorrelated. Two exemplary approaches are described herein: (a) estimate a joint distribution for the fⱼ(ω), and simulated subjects are created by drawing from that joint distribution; (b) use the covariance matrix to determine a new set of basis functions, Qⱼ(t), and new coefficients, sᵢ^{k}, which are not correlated (the covariance is zero). The advantage of the former approach includes fewer required data, is computationally simpler, is an optimal expansion, and can provide powerful insight into the behavior of the feature. This approach is closely related to both the principal component method (PCM) and the method of factor analysis and is a central feature of the K-L decomposition. After the new, uncorrelated coefficients sⱼ(ω) are determined, it is much easier to estimate their joint distribution and draw from that distribution to create simulated subjects. Additionally, under some conditions, the new coefficients will also be independent.

The latter approach is accomplished as follows: since the covariance matrix is real, symmetric, and nonnegative, it has J+1 real eigenvalues λⱼ (with λⱼ≦0) and J+1 orthonormal eigenvectors Ψ^{j}. The eigenvectors and eigenvalues have two important properties. First, multiplying an eigenvector by the matrix from which it was derived reproduces the eigenvector scaled by the eigenvalue. Thus,

$${\sum }_{l = 0}^{j} {C}_{jl} {ψ}_{l}^{n} = {λ}_{n} {ψ}_{j}^{n} , ( j = 0 … J , n = 0 … J ) .$$

Second, the eigenvectors are orthonormal,

$${\sum }_{j = 0}^{J} {ψ}_{j}^{n} {ψ}_{j}^{l} = {δ}_{nl}$$

where δₙₗ=0 if n≠1, and δₙₗ=1 if n=1. Moreover, the eigenvectors span the space so that any vector can be represented as the sum of coefficients times the eigenvectors.

Using the eigenvectors of the covariance matrix, it is possible to calculate new coefficients and basis vectors for expansion of the trajectory that have the desired property that the coefficients are uncorrelated. The first step in this calculation is to expand the coefficients qⱼ^{k} in terms of the eigenvectors and new coefficients sᵢ^{k},

$${q}_{j}^{k} = {\sum }_{i = 0}^{J} {s}_{i}^{k} {ψ}_{j}^{i}$$

This forumla is then used to solve for the sᵢ^{k} in terms of the qⱼ^{k}. Multiplying each side by the nth eigenvector and summing over its elements yields

$${\sum }_{j = 0}^{J} {q}_{j}^{k} {ψ}_{j}^{n} = {\sum }_{j = 0}^{J} {\sum }_{i = 0}^{J} {s}_{i}^{k} {ψ}_{j}^{i} {ψ}_{j}^{n}$$

But by the orthogonality of the eigenvectors,

$${\sum }_{j = 0}^{J} {\sum }_{i = 0}^{J} {s}_{i}^{k} {ψ}_{j}^{i} {ψ}_{j}^{n} = {s}_{n}^{k}$$

This equation defines the new coefficients in terms of the qⱼ^{k} and the eigenvectors; the new coefficients are a linear combination of the old coefficients and are weighted by the elements of the corresponding eigenvectors. Thus, for the n^{th} new coefficient, we obtain

$${s}_{n}^{k} = {\sum }_{j = 0}^{J} {q}_{j}^{k} {ψ}_{j}^{n}$$

Similarly, we can define new basis vectors Qⱼ(t) as linear combinations of the old basis vectors weighted by the elements of the eigenvectors. That is,

$${Q}_{n} ( t ) = {\sum }_{j = 0}^{J} {ψ}_{j}^{n} {P}_{j} ( t )$$

It can be verified that the coefficients sⱼ(ω) and sₙ(ω) are not correlated. Thus,

$$〈 {s}_{j} ( ω ) {s}_{n} ( ω ) 〉 = 1 / K {\sum }_{k = 1}^{K} ( {\sum }_{i = 0}^{J} {q}_{i}^{k} {ψ}_{i}^{j} ) ( {\sum }_{l = 0}^{J} {q}_{l}^{k} {ψ}_{l}^{n} ) \\ = {\sum }_{i = 0}^{J} {\sum }_{l = 0}^{J} {C}_{il} {ψ}_{i}^{j} {ψ}_{l}^{n} \\ = {\sum }_{i = 0}^{J} {λ}_{n} {ψ}_{i}^{j} {ψ}_{i}^{n} = {λ}_{n} {δ}_{jn}$$

Further, by substituting the new coefficients and basis functions, it can be verified that these new coefficients and basis functions satisfy the original equation for the trajectory of the feature. Thus

$${F}^{k} ( t ) = 〈 F ( t ) 〉 + {\sum }_{j = 0}^{J} {\sum }_{l = 0}^{J} {s}_{l}^{k} {ψ}_{j}^{l} {P}_{j} ( t ) and$$

$${F}^{k} ( t ) = 〈 F ( t ) 〉 + {\sum }_{l = 0}^{J} {s}_{l}^{k} {Q}_{l} ( t )$$

Starting from an arbitrary set of basis functions Pⱼ(t), this method can be used to derive a set of basis functions Qⱼ(t), which cause the trajectories of real persons to best fit the observed data (i.e., passing through all observed points), but for which the coefficients, sⱼ(ω), are uncorrelated.

This method of expansion has many advantages. First, it corrects for first-order correlations. If the random process is Gaussian, then correcting for first-order correlations corrects for all higher order correlations and consequently makes the random variables sⱼ(ω) independent. Although assuming a Gaussian distribution is frequently reasonable, the method does not correct for higher order correlations. If higher order correlations are found to be important, then forming the joint distribution of the sⱼ(ω) may still be necessary. Even in this case, however, forming these joint distributions will still be easier because the first-order correlations will have been removed.

A second advantage of this method is that it provides insight into the nature of the trajectory of the feature. The K-L expansion can be optimal if the expansion in is truncated at the m^{th} term, the mean square error is smallest if the basis functions are the Qⱼ(t) and the coefficients of the expansion are the sⱼ^{k} as derived above. By exploring the rate at which the expansion converges when different basis functions are used and by exploring the components of the expansion's trajectory, not only can we learn about the biology of the feature but the new basis functions are likely to converge faster in the sense that fewer terms are needed to get a good fit of the data. This event can provide information about the minimum number of observations needed to formulate an accurate description of the feature's trajectory: the number of data points needed is equivalent to the number of expansion terms which have important coefficients. For example, if the data are well fitted by using only two terms in the expansion, only two data points will be needed to fit the entire function. This fact is of importance for future data collection.

The importance of each term in the expansion is assessed by examining the size of the eigenvalues λₙ. This process is similar to factor analysis. The covariance matrix has diagonal elements σₙ², where

$${σ}_{n}^{2} = 1 / K {\sum }_{k = 1}^{K} {( {q}_{n}^{k} )}^{2} .$$

The sum of the diagonal elements of C is

$${σ}^{2} = {\sum }_{n = 1}^{J} {σ}_{n}^{2} .$$

This sum is conserved in diagonalization, so the sum of the eigenvalues is also σ². Just as in the factor analysis, the size of each eigenvalue represents the importance of each term in the expansion of the process, with the terms with the largest eigenvalues contributing the most to the convergence of the series. Consequently, the number of terms in the expansion can be reduced by keeping only those which have the largest eigenvalues. One frequently used method involves ordering the eigenvalues by size, calculating their sum, and retaining the first m eigenvalues such that

$${\sum }_{i = 0}^{i = m} {λ}_{i} \geq Frac * {σ}^{2} ,$$

where Frac is the percentage of the original variance the reduced eigenvector set will reproduce. In an exemplary embodiment, Frac is chosen to be substantially close to 0.9. Standard (but nonetheless empirical) methods of choosing the number of eigenvalues to retain in the factor analysis method are well known in the art and not described here.

Thus, the Fourier expansion with the K-L decomposition produces a new set of coefficients which are easier to use because they are uncorrelated (and perhaps independent). If higher order correlations exist, the K-L procedure makes finding the joint distribution of the coefficients easier. In addition, because the expansion is optimal, fewer terms in the series may be needed to adequately represent the random process. The K-L procedure also enables identification of terms to be retained.

Finally, the flow culminates at 1056 where it is now appropriate to create new simulated subjects by drawing values from the distributions of the random variables for the coefficients and using these values to derive simulated trajectories for as many subjects as desired.

Determining distribution of data samples from a set of samples (sᵢⱼ^{k}) is a standard problem which is often addressed using maximum likelihood techniques. First, the application of this technique for a feature which does not depend on another feature is described, then to include dependence on other features.

Designating the samples as sᵢⱼ^{k}, where k represents the k^{th} individual, j represents the j^{th} term in the expansion, and i represents the i^{th} feature, the probability distribution of the random variable, sᵢⱼ(ω) from which the samples were obtained is denoted as ρᵢⱼ and is characterized by a small number of parameters:
ρᵢⱼ(x,θ₁^{ij},θ₂^{ij}, . . . θ_{N}^{ij})dx=ρᵢⱼ(x,\vec{Θ}^{ij})dx=P(x<sᵢⱼ(ω)<x+dx)

P( . . . ) is the probability that the random variable sᵢⱼ(ω) lies in the range between x and x+dx. \vec{Θ}ij={θₙ^{ij},n=1 . . . N} are the parameters of the distribution of sᵢⱼ(ω), a distribution to be determined. The probability of obtaining the samples sᵢⱼ^{k} is the likelihood and is related to the distribution ρᵢⱼ and to the samples sᵢⱼ^{k} by the likelihood function

$$L ( {{Θ}^{->}}^{ij} , {s}_{ij}^{1} , {s}_{ij}^{2} , … {s}_{ij}^{K} ) = {\sum }_{k = 1}^{K} {ρ}_{ij} ( {s}_{ij}^{k} , {{Θ}^{->}}^{ij} )$$

An estimate of the parameters \vec{Θ}^{ij} is obtained by maximizing the likelihood as a function of the parameters θ₁^{ij}, θ₂^{ij}, . . . θ_{N}^{ij}

The following Example 2 is provided to further illustrate the above-described decorrelation workings of the present invention in conjunction with and referencing the exemplary data provided in Example 1 above:

To decorrelate the calculated fⱼ^{k} of Example 1, first the average value of the fⱼ^{k} is removed from the distribution of each fⱼ and then the correlation matrix is formed of the resulting coefficients. This matrix is denoted as Cᵢⱼ and an example of matrix for this set of coefficients as calculated in Example 1 is shown in Table 1 below.

TABLE 1
Correlation Matrix Cᵢⱼ

| Correlation Matrix- | | | | | | | |
|---|---|---|---|---|---|---|---|
| Row/column | 1 | 2 | 3 | 4 | 5 | 6 | 7 |
| 1 | 125.0011 | −1125.0165 | 5250.05775 | −10500.077 | 9843.793313 | −4331.258663 | 721.875 |
| 2 | −1125.0165 | 22125.2475 | −110250.8663 | 220501.155 | −206719.3997 | 90956.37994 | −15159.375 |
| 3 | 5250.05775 | −110250.8663 | 551253.0319 | −1102504.043 | 1033596.024 | −454781.7048 | 75796.875 |
| 4 | −10500.077 | 220501.155 | −1102504.043 | 2205005.39 | −2067190.532 | 909563.1064 | −151593.75 |
| 5 | 9843.79331 | −206719.3997 | 1033596.024 | −2067190.532 | 1937989.987 | −852715.1848 | 142119.1406 |
| 6 | −4331.2587 | 90956.37994 | −454781.7048 | 909563.1064 | −852715.1848 | 375194.5995 | −62532.42188 |
| 7 | 721.875 | −15159.375 | 75796.875 | −151593.75 | 142119.1406 | −62532.42188 | 10422.07031 |

If the fⱼ^{k} s had not been correlated, the numbers along the diagonal path of (1,1) to (7,7) in the correlation matrix of Table 1 would have had a large numerical differential with other numbers in the table, and further processing would have then been unnecessary.

Since the fⱼ^{k} s in Table 1 are correlated, the eigenvalues and eigenvectors of Cᵢⱼ matrix must be found. As described above, the eigenvectors are used to produce a new set of basis functions Qⱼ(t), and a new set of coefficients s^{k}j. In the basis functions determined by the Qⱼ(t), the correlation function of the new coefficients s^{k}j is diagonal (i.e. uncorrelated). The eigenvectors are then used to determine which of the new basis functions is most important in expanding the trajectories. The new expansion is desireable in a number of ways as described above.

Table 2 shows the eigenvalues for the Cᵢⱼ matrix of Table 1.

TABLE 2
Eigenvalues of the Correlation matrix

| | | | | | | | |
|---|---|---|---|---|---|---|---|
| Eigenvalues | 5101964.28 | 149.6971869 | 1.348395025 | 1.69187E−10 | 6.2168E−11 | −1.59923E−12 | −6.77766E−12 |

Since there are seven dimensions in the matrix, there are seven eigenvalues. As shown, however, only the left two of the eigenvalues are large and the others are very close to zero. It should be noted that since the eigenvectors and eigenvalues are determined numerically, the results may have some negligible error caused by numerical approximations and rounding. Since only two of the eigenvalues are not close to zero, only two functions are necessary to reproduce the statistics of the space of trajectories. Table 3 below shows the eigenvectors of the matrix Cᵢⱼ which are used to determine the new basis expansion functions.

TABLE 3
Normalized Eigenvectors of the Correlation matrix Cᵢⱼ

| Normalized | | | | | | | |
|---|---|---|---|---|---|---|---|
| Eigenvectors- | | | | | | | |
| Row/column | 1 | 2 | 3 | 4 | 5 | 6 | 7 |
| 1 | −0.0031315 | 0.707579343 | 0.120412793 | 0.03173556 | −0.199411047 | 0.079083239 | 0.661661814 |
| 2 | 0.06574214 | −0.704953842 | 0.117879707 | 0.03173556 | −0.199411047 | 0.079083239 | 0.661661814 |
| 3 | −0.3287052 | −0.014859284 | −0.65134236 | −0.307175909 | 0.523826746 | 0.117478323 | 0.291431948 |
| 4 | 0.65740968 | 0.03151091 | 0.303195945 | −0.076815788 | 0.674110401 | 0.024755053 | 0.118124867 |
| 5 | −0.6163211 | −0.030885735 | 0.465370383 | 0.450935555 | 0.436023995 | −0.071430679 | 0.063739208 |
| 6 | 0.27118108 | 0.014073656 | −0.474624938 | 0.833226618 | 0.034714355 | 0.065398083 | 0.03528921 |
| 7 | −0.0451968 | −0.002412822 | 0.116584985 | 0.010887236 | −0.018142897 | 0.981681447 | −0.142173161 |

The new functions are Q₀, and Q₁ as shown below,

$$\begin{matrix}{Q}_{0} ( y ) = - .003135 + 0.06574214 y - 0.3287052 * {y}^{2} + \\ 0.65740968 * {y}^{3} - 0.6163211 * {y}^{4} + \\ 0.27118108 * {y}^{5} - 0.0451968 * {y}^{6} \\ {Q}_{1} ( y ) = 0.7075793 - 0.704953842 y - 0.01485928 * {y}^{2} + \\ 0.03151091 * {y}^{3} - 0.030885735 * {y}^{4} + \\ 0.014073656 * {y}^{5} - 0.002412822 * {y}^{6}\end{matrix}$$

where y is the function (t/50) used in Example 1. Since J was set to 6, the terms in each of the Q₀, and Q₁ series also proceeds to seven.

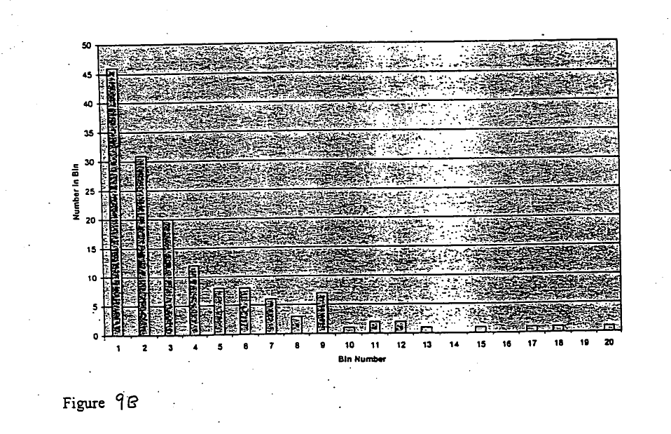

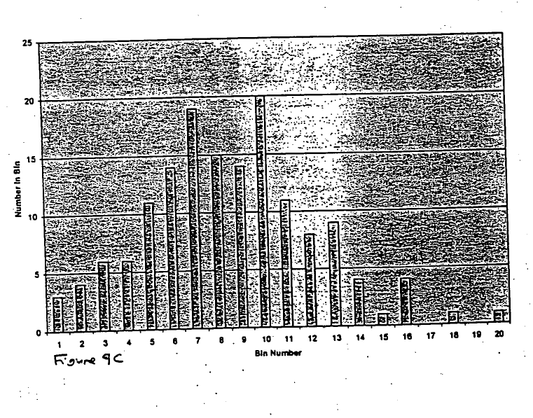

The samples for the distribution for the random variables s₀ and s₁ are shown in FIGS. 9B and 9C. The distribution for s₀ looks like an exponential distribution. Using maximum likelihood techniques described above, the distribution for s₀ is found to be P₀(s)=exp(−(s+λ)λ)λ where λ=3513. As shown in FIG. 9B, the distribution for s₁ resembles a normal distribution. Also, using maximum likelihood techniques, the distribution for s₁ is found to be normal with standard deviation 12.4, as shown in FIG. 9C.

In an exemplary embodiment, the presented mathematical model may be used in cases of incomplete data, such as when person specific data on values of the feature exist at several times (but not necessarily at the same times for each person). This situation is a realistic one for many problems today and constitutes a restriction shared by most statistical models, such as regression models. Moreover, person specific data are likely to become far more available with increased use of automated clinical information systems.

Currently, a large class of clinical conditions exist for which the feature is difficult or practically impossible to observe and for which the only data available relate to occurrence of clinical events. For example, several large epidemiologic studies provide data on probability of heart attack for subjects of various ages, but no large studies exist on degree of occlusion of coronary arteries (because the required measurement entails use of often risky, expensive tests). In such cases, choice of approach depends on availability of data from ancillary sources on the relation between feature and clinical event. When available, data such as reports on degree of occlusion in patients who recently had a heart attack can be used to translate epidemiologic data on clinical events into estimates of values of the feature, and the process described above may then be used to complete the derivations of equations for the trajectory of the feature.

When there are no data at all on the value of a feature at the time of clinical events, a different approach may be used. In this case the method is not dependent on equations for the trajectory of the true values of the feature because such an approach is not possible if there are truly no systematic observations of the feature. Instead, the method depends on equations for an imaginary feature whose only purpose is to accurately reproduce the observed occurrence of clinical events. For this purpose, the desired feature can be assigned an arbitrary value when the event occurs. If there is more than one clinical event to be simulated, the arbitrary values should correspond to the order in which the events occur. If the events occur in different orders in different subjects, a strong likelihood exists that the events are caused by different features, and equations for each feature can be derived accordingly. Although this approach provides little information about the true value of the feature, it does provide what is needed for an accurate simulation, which is a feature that produces clinical events at rates that “statistically match” the occurrences of real clinical events.

Finally, some cases involve situations when there are no person specific data, and the only available data are aggregated over a population. For example, there may be data on the age distribution of patients diagnosed with various stages of a cancer, but no person specific data on the ages at which particular individuals pass through each stage. Of course, if there are data from other sources that relate the clinical events to the values of the feature (in this example the “stage” of the cancer), those data can be used to resolve the problem as described in the previous section. Assuming there are no such data, there are two below-described main options, depending on whether there is reason to believe that the clinical events are correlated.

Under the first option, if an assumption can be made that the clinical events are not correlated, then they can be modeled as if caused by two different features, and the modeling problem is reduced to one of the cases discussed above. If it is undesirable to assume that the events are uncorrelated, then a model is to be postulated that describes the correlation as follows: first a search is made for any data on which the presumption of correlation was based, and those data are used to develop a model. But even if no such data are available there may be plausible reasons to postulate a model. For example, an assumption can be made that some individuals have an “aggressive” form of the disease, implying that they will move through each stage relatively rapidly, whereas others may have more “indolent” cancers, implying that their disease will tend to progress more slowly. Thus if a person with an aggressive disease was in the first 10% in terms of the age at which they developed the first stage of the disease, it might be plausible to assume that they will be in the first 10% in the pace at which they progress through subsequent stages. If a specific correlation is postulated, then it is possible to convert the cross-sectional data into a set of person specific longitudinal data. At this stage, the problem is transformed into the original case and can be solved by the above described methods.

FIG. 11 is a diagram illustrating another embodiment of the present invention. Here, the mathematical model of the present invention can be used for multiple features common to a subject group, and for generating trajectories that represent the interdependence of these common features, such as plotting a coronary occlusion as function of blood pressure or cholesterol level. As shown in the flow diagram of FIG. 11, generating the continuous mathematical model of two features starts at 1102 where two or more sample data sets of different features from each subject in the subject group are selected. Next, at 1104, a set of expansion functions to be used in the representation of the each of the sample data sets is also selected. At 1106, the selections made in 1102 and 1104 are used to mathematically expand each member of each sample data set in the form of a summation of the results of multiplying each of the expansion functions in the set of expansion functions of the data set by a different mathematical parameter. Next, at 1108, a value for each of the different mathematical parameters is determined from the mathematical expansion of 1106 and the data set for each subject in the subject group. Next, at 1110, a corresponding distribution function for each of the mathematical parameters is derived based on the values determined in 1108. Next, at 1112, a continuous mathematical model for each of the features selected in 1102 is generated from the derived distribution functions of 1110 and the expansion functions of 1106. Next, at 1114, the mathematical models for each of the features generated in 1112 are correlated. Finally, at 1116, a continuous mathematical model is generated based on the correlation results of 1114 and the derivation results of 1110, that accounts for all the features selected at 1102. Many of the details of operations of this embodiment of the present invention, particularly those in 1102 to 1112 were discussed in conjunction with FIG. 1 or can be readily understood therefrom. The following detailed description is therefore focused primarily on the correlating operations performed in 1114 of FIG. 11.

At 1114, the equations for multiple features depend on the extent to which features are independent such that they depend only on time (e.g., a person's age) and do not depend on other features or other factors that may vary across individual persons. It should be apparent that for features that are independent as such and depend only on an individual's age, the methods already described can be used to derive equations for as many such features as desired.

The difficulties arise when the trajectory of a feature depends on other features or other risk factors. For the example of coronary artery disease, the rate of coronary artery occlusion depends not only on age but also on other features, such as cholesterol level, blood pressure level, tobacco use, and diabetes. Collectively these are referred to as “risk factors” throughout this disclosure with the understanding that this term covers a wide range of disparate factors. Some of these factors are fixed characteristics (e.g., sex, race), some are biologic features (e.g., cholesterol), some are behaviors (e.g., smoking), some can be modified by interventions while some cannot. Fortunately, the method for incorporating risk factors in the trajectory of a feature works for all types of risk factors. Explained in greater detail below is incorporating a dependence on features, with the understanding that the method can easily incorporate dependence on other risk factors.

First, it should be noted that the dependence of one feature on other features is already incorporated in the data, and therefore is incorporated in the coefficients and basis functions estimated for each individual. The task then, is to separate that dependence and to represent it explicitly in the coefficients or basis functions of the equations for the trajectory of the feature. This is needed if a general model is to be developed that can be used to analyze interventions, not only in clones of the original population, but also in a wide variety of other populations that will have different distributions of risk factors.

The separation of the dependence on other features requires care, because the data for estimating the equations for a feature contain all the dependence of the feature on age. But the data are not separated into the dependence of the feature as a function of age, at a fixed value of another feature, or the dependence of the feature as a function of another feature, at a fixed age.

The dependence can be represented either in the coefficients or in the basis functions. In the Fourier expansion approach, the dependence is represented in the coefficients. Described herein are methods to determine the distributions of the coefficients from the available data, when the features are related in a Fourier expansion and one feature depends on another. In the Hybrid expansion approach, the dependence is represented in the basis functions or in both the basis functions and the coefficients. Using the Hybrid approach facilitates inclusion of the dependence of one feature on another because the independent features (such as total cholesterol level in the expansion of the coronary artery occlusion) are explicitly separated out and included in the basis functions. The trade off is that the Hybrid expansion is not guaranteed to converge and the equations for determining the coefficients for the hybrid expansion may be ill-conditioned.

Using the same notation as in the equations, the distributions of the coefficients of the random process for the i^{th} feature, Fᵢ(ω,t) can be considered to be conditional on the coefficients of the random processes of other features. To allow the distributions to be conditional, we represent the Θ^{ij} as functions of the other coefficients, i.e.,
P(x<sᵢⱼ(ω)<x+dx|ŝᵢ(ω)=\hat{x}ᵢ)=ρᵢⱼ(x, \vec{Θ}^{ij}(\hat{x}ᵢ))

The set ŝᵢ(ω) represents the coefficients of all features other than feature i (i.e., all s_{i′j′}(ω) for i′≠i and all j′), and \hat{x}ᵢ represents the set of all x except for xᵢ. The \vec{Θ}^{ij}(\hat{x}) may be chosen to be a function of the coefficients \hat{x}ᵢ in many different ways. One common choice is using and expansion linear in the coefficients, e.g.,

$${{Θ}^{->}}^{ij} ( {\hat{x}}_{i} ) = {{Θ}^{->}}^{ij} ( {{β}^{->}}_{0}^{ij} + {\sum }_{{i}^{′} \neq i , all {j}^{′}}^{I} {{β}^{->}}_{{i}^{′} {j}^{′}}^{ij} {x}_{{i}^{′} {j}^{′}} )$$

another alternative is using an expansion which depends on some powers of the coefficients, e.g.,

$${{Θ}^{->}}^{ij} ( {\hat{x}}_{i} ) = {{Θ}^{->}}^{ij} ( {{γ}^{->}}_{0}^{ij} + {\sum }_{{i}^{′} \neq i , all {j}^{′}}^{I} {\sum }_{l = 0}^{L} {{{γ}^{->}}_{{i}^{′} {j}^{′} l}^{ij} ( {x}_{{i}^{′} {j}^{′}} )}^{l} )$$

In general, \vec{Θ}^{ij}(\hat{x}) can be represented as
\vec{Θ}^{ij}(\hat{x}ᵢ)=\vec{Θ}^{ij}(\vec{β}₀^{ij}H^{ij}(\hat{x}))
where H(\hat{x}) can be either of the forms shown in the equations or some other function of the \hat{x}, e.g.,

$${H}^{ij} ( \hat{x} ) = exp ( {\sum }_{{i}^{′} \neq i , all {j}^{′}}^{I} {\sum }_{l = 0}^{L} {{{γ}^{->}}_{{i}^{′} {j}^{′} l}^{ij} ( {x}_{{i}^{′} {j}^{′}} )}^{l} )$$

The likelihood of obtaining all the sample values sᵢⱼ^{k} for all the individuals k=1 . . . K, and all the features i, and all the coefficients j for the expression is given by the equation

$$L ( {B}^{->} , {s}^{->} ) = {\prod }_{k = 1 , i , all j}^{K , I} {ρ}_{ij} ( {s}_{ij}^{k} , {{Θ}^{->}}^{ij} ( {\hat{x}}_{i} ) )$$

where \vec{B} is the vector of all coefficients \vec{B}={\vec{β}₀^{ij}\vec{β}_{i′j′}^{ij}} or in \vec{B}={\vec{β}₀^{ij},\vec{γ}_{i′j′1}^{ij}} and where \vec{s} represents the set of all coefficients obtained by observations on all subjects. The \vec{B} coefficients are determined by maximizing the likelihood. These coefficients determine the probability distribution function for the coefficients of each term of each feature.

After functions have been derived for the natural histories of features, linking features to events is a fairly straightforward process. First, biologic events are represented by the values of features. Tests can be applied to measure a feature at any time, and the raw result of the test is read directly from the value of the feature. Uncertainty, random error, and systematic error in tests are easy to include.

For clinical events, for example, if the feature was observed through the clinical event the trajectory will automatically reproduce the occurrence as required. Otherwise, it is necessary to describe or model how the clinical event is linked to the feature. The appropriate model will depend on the data available. For example, a standard medical text suggests that angina pain tends to occur when degree of coronary artery occlusion approaches 70%. Clinical events can also be defined as more complex functions of a feature. For example, rapid weight change in a patient with congestive heart failure is an indication to regulate dose of diuretics. Because values of all features are continuously available through equations for trajectories, it is a relatively easy task to define models which determine occurrence of clinical events on the basis of evidence or customary practice.

Effects of health interventions can also be modeled either as a change in value of a feature, as the rate of change of a feature, or as a combination of both types of change. The choice and the exact model depend on he intervention and on the available data.

Based on the above disclosure, the present invention offers several advantages over the prior art: the mathematical model presented herein is a true simulation with a highly detailed one-to-one correspondence between objects in the model and objects in the real world. The level of detail allows for detailed description of events and features, such as occlusion of specific coronary arteries at specific areas along the artery or propensity of a particular physician to follow a particular guideline. The presented model is also truly continuous and can be applied in representation of practically any event occurring to any subject at any time. This characteristic is particularly important because many decisions involve timing such as in health care where the factor such as how frequently to monitor a patient, when to initiate or modify a treatment, how frequently to schedule follow up visits, how long to wait before taking some action all play an important role in the decision making process.

In an exemplary embodiment, the invention may be implemented using object-oriented programming with the major classes of objects in the model to include subjects such as members, patients, facilities, personnel, interventions, equipment, supplies, records, policies, and budgets. Those of ordinary skill in the art will now realize that the invention may also be implemented using any appropriate programming techniques.

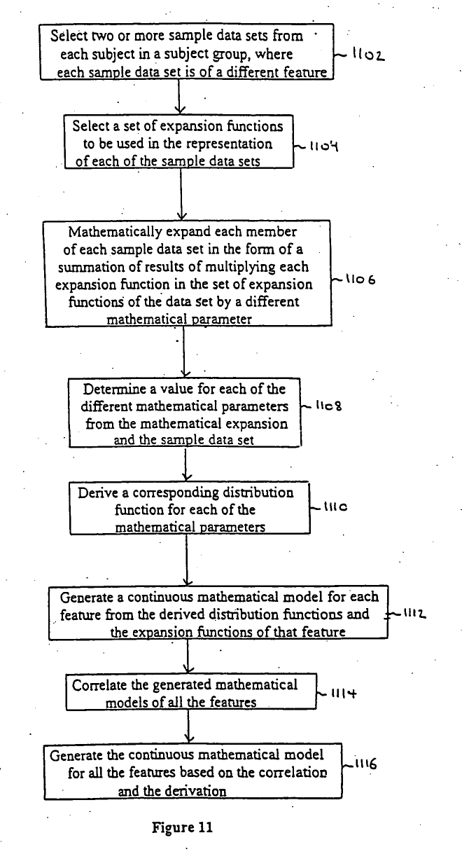

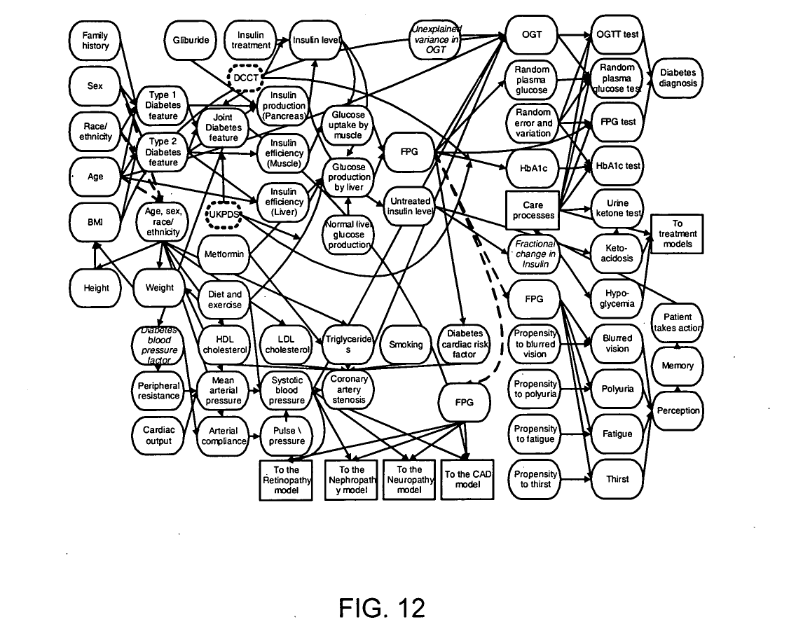

The process for building a model may comprise five steps. The first is to develop a non-quantitative or conceptual description of the pertinent biology and pathology—the variables and relationships as best they are understood with current information. For this step, experts and basic texts may be consulted. The result of this step may be described in a figure like FIG. 12, discussed in more detail below. The second step is to identify studies that pertain to the variables and relationships. Typically, these are the basic, epidemiological, and clinical studies that experts identify as the foundations of their own understanding of the disease. The third step is to use the information in those studies to develop equations that relate the variables. The development of any particular equation involves finding the form and coefficients that best fit the available information about the variables. The next step is to program the equations into a computer using an object oriented language. This is followed by a series of exercises in which the parts of the model are tested and debugged-first one at a time, and then in appropriate combinations, using inputs that have known outputs. The next step is to use the entire model to simulate a complex trial. This tests not only the individual parts, but the connections between all the parts. It also is a rigorous test for any remaining bugs in the software. Finally, this may be performed for a broad range of studies that span different populations, organ symptoms, and treatments. The calculations may be performed using distributed computing techniques.

In another embodiment of the present invention, a model specifically for diabetes may be generated. Many of the features in the model represent known and measurable biological variables such as fasting plasma glucose (FPG), diagnostic blood pressure, or LDL cholesterol levels. However, the concept of a feature is very general and can include patient characteristics (such as sex, race, ethnicity, etc.), patient behaviors (such as smoking), behavioral phenomena (for example, ability to ready an eye chart), and conceptual phenomena (such as the “spread” of cancer). The model may include diabetes and its complications, including coronary artery disease, congestive heart failure, and asthma.

This model may continuous in time, in that there are no discrete time steps, and any event can occur at any time. Biological variables that are continuous in reality may be represented continuously in the model; there are no clinical “states” or “strata”.

The mechanism for generating the diabetes model utilizes differential equations, object oriented programming, and features. These have been described above along with their mathematical foundations.

The model may be described in parts: the anatomy, the “primary features” that determine the course of the disease, risk factors, incidence and progression of the disease; glucose metabolism, signs and tests, diagnosis, symptoms, health outcomes of glucose metabolism, treatments, complications, deaths from diabetes and its complications, deaths from other causes, care processes, and system resources. FIG. 12 is a diagram illustrating the variables pertinent to the development and progression of diabetes, and their relationships in accordance with an embodiment of the present invention. In this figure, circles represent variables. Lines represent relationships. In general, the arrows coming in to any variable represent an equation. Squares represent other parts of the model that will typically have their own diagrams, often with dozens of variables and relationships. Dashed lines represent validated portions of the model.

Anatomy

In the model all of the simulated people/patients may have organs such as hearts, livers, pancreases, gastrointestinal tracts, fat, muscles, kidneys, eyes, limbs, circulatory systems, brains, skin, peripheral nervous systems, etc. Each of these organ systems may in turn have the necessary parts and subparts. For example, the hearts may all have four coronary arteries, atria, ventricles, myocardium, and sino-atrial nodes. The coronary arteries may have lumens, which may have plaque or thrombi at any point. Pancreases may have beta cells, kidneys may have glomeruli, etc.

As in real organ systems, in the model all the organs and their parts have functions. For example, a function of the beta cells is to produce insulin, the function of the coronary arteries is to carry blood to the myocardium, the function of the myocardium is to pump blood and maintain output, and so on. Furthermore, the functions of any part can change or become abnormal, as in real diseases. For example, in the model the uptake of glucose by the simulated muscle cells can fail to respond to insulin. When the functions of organs become abnormal, that in turn may affect the functioning of other organs. For example, a change in insulin levels may affect the production of glucose by the liver.

Primary Features

The physiology of a person may be conceptualized as a collection of continuously interacting objects referred to above as features. Features can represent real physical phenomena (e.g., the number of milligrams of glucose in a deciliter of plasma), behavioral phenomena (e.g., ability to read a Snelling chart), or conceptual phenomena (e.g., the progression of cancer). The full model may contain hundreds of features. When particular features are central to the occurrence, progression, and treatment of a disease, they may be called primary features.

In an embodiment of the present invention, the causes of diabetes may be represented as two primary features, called “Type 1 diabetes feature” (DF₁) and “Type 2 diabetes feature” (DF₂). Three other features in the model are important factors in the cause and manifestations of diabetes: the insulin amount (I), the efficiency of insulin use (E), and the effects of insulin resistance (H). In the model, type 1 diabetes is characterized by an inability of pancreatic beta cells to produce appropriate amounts of insulin. Thus in the model type 1 diabetes primarily affects the value of I, through the type 1 diabetes feature. Type 2 diabetes is a result of a complicated set of interactions involving all five features, and will be described in more detail below.

Risk Factors, Incidence, and Progression

For type 1 diabetes, the feature DF₁ is a function of age, sex, family history, and race/ethnicity. For type 2 diabetes, the feature DF₂ is a function of age, sex, race/ethnicity, body mass index (BMI), and a factor that registers the effect of glucose intolerance. In an embodiment of the present invention, these formulas may be represented as follows

$$\begin{matrix}{DF}_{1} ( t ) = ( 1 - exp ( - exp ( a + bt + {ct}^{2} + \\ {dt}^{3} + {et}^{4} + {ft}^{5} ) ) * famhis ) / {ξ}_{1} \\ {DF}_{2} ( t ) = ( 1 - exp ( - a * JGT ( {ξ}_{3} ) / ( 1 + exp ( - \frac{( t - b )}{c} ) ) ) ) * \\ RBMI ( BMI ) / {ξ}_{2}\end{matrix}$$

Race/ethnicity and sex are included through the values of the parameters a, b, c, d, e, and f. These equations may be scaled so that a person first begins to develop symptoms when DF₁=1 or DF₂=1. ξ₁ is a random value drawn from a uniform distribution on the interval (0, 1) hereinafter denoted as U[0, 1]. Drawing ξ₁ from U[0, 1] will cause the individuals in a large population (of a particular race/ethnicity/sex) to get type 1 diabetes at rates that match the observed age-specific incidence rates for that population, while allowing every individual to have a unique history of diabetes, including never getting type 1 diabetes. Similar intervals may be used for other values of ξ. famhis registers a patient's genetic propensity to develop the disease, based on their family history. It is set at birth and does not change.

RBMI may be the relative risk associated with BMI, and is a continuous function of a person's BMI as follows.
RBMI(BMI)=a+b/(1+e^{-(BMI-c)/d})

The values of the coefficients may be different for men and women.

Some people have virtually no impairment in glucose tolerance and are very unlikely to get diabetes. Also, some people have very poor glucose tolerance, and are about twice as likely to get diabetes, everything else being equal. These may be represented as follows.
IGT(ξ₃)=2(1−ξ₃)
Glucose Metabolism

In the diabetes part of the model, the main biological variables are fasting plasma glucose (FPG), Hemoglobin A_{1c}(HbA_{1c}), tolerance to a glucose load (OGT), random plasma glucose (RPG), and blood pressure.

In the progression of diabetes, the development of signs, symptoms, and complications, and the response to treatments are determined primarily by the steady state level of glucose, which can be represented either by the fasting plasma glucose or HbA_{1c}. In the model, the FPG in a person with diabetes is determined by six variables that represent: the average FPG in people who do not have diabetes; hepatic glucose production; the effect of insulin resistance on hepatic glucose production; the insulin amount (I); the efficiency with which the body (liver, muscle, and fat) uses insulin (E); and the two primary diabetes features (DF₁ and DF₂). In people who develop type 3 diabetes, the simulated liver cells develop a resistance to the effects of insulin. This causes the simulated liver to produce too much glucose. In response, the simulated beta cells produce more insulin. Over time, this compensatory mechanism begins to fail, through a combination of decreased insulin production (e.g., “beta cell fatigue”), and increasing resistance to insulin by the liver. In addition, the uptake of glucose by the simulated muscles and fat gradually decreases due to insulin resistance affecting those organs. Taken together, these factors create a relative deficiency of insulin, with resulting increases in glucose. In an embodiment of the present invention, these relationships may be addressed as follows.

First a person's fasting plasma glucose level (FPG(t)) may be determined by their basal hepatic glucose production (FPG₀(t)), their insulin level (I), and the efficiency with which insulin affects liver production of glucose and uptake of glucose by the muscle and fat (E). This may be represented as:
FPG(t)=FPG₀/(I*E)

The efficiency of insulin may be scaled so that E=1 in the absence of diabetes, and 0≦E≦1 in the presence of diabetes. The specific equation in an embodiment of the present invention may be a function of the type 2 diabetes feature as follows.

$$E ( {DF}_{2} ) = {( a + b / ( 1 + {( {DF}_{2} / c )}^{d} ) )}^{\frac{1}{2}}$$

or specifically as:

$$E ( {DF}_{2} ) = {( 0.284 + 0.717 / ( 1 + {( {DF}_{2} / 0.994 )}^{2.508} ) )}^{\frac{1}{2}}$$

A person's basal glucose production, FPG₀(t) may be determined by the basal production in people who do not have diabetes, G(t), and the degree of insulin resistance in a person with diabetes (H). Insulin resistance gets worse as the disease progresses, H(DF₂).
FPG₀(t)=G(t)*H(DF₂(t))

The degree of insulin resistance is a function of the severity of the diabetes, and is related to the efficiency with which the liver, muscle, and fat respond to insulin. This may be represented generally as:
H(DF₂(t))=1/(MAX[E²(DF₂(t+a)),b])

or specifically, as:
H(DF₂(t))=1/(MAX[E²(DF₂(t+5)),0.640])

In people who do not have diabetes, their basal hepatic production of glucose, G(t), gradually increases with age (t). This may be expressed generally as:
G(t)=(a+bt^{1.5}−c*t³+Δ_{g})/(d−eexp(−DF₂(t)ξ₂))

or specifically as:
G(t)=(86.955+0.0229t^{1.5}−5.539*10⁻⁶*t³+Δ_{g})/(1.503−0.509exp(−DF₂(t)ξ₂))

The basal hepatic production varies across individuals, and the degree of the spread is different for different ages. Generally, this may be represented as:
Δ_{g}=N[a,b(t)]
and specifically may have a standard deviation of (0.0145t+8.1):

For people with type 1 diabetes, the insulin level, I, decreases as the severity of the disease (DF₁) increases. For people with type 2 diabetes, the insulin level is determined by the efficiency with which their organs respond to insulin (E), and to the degree of insulin resistance (H). Both of those worsen with increasing severity of the disease (DF₂). This may be represented generally as:
I(DF₁, DF₂)=H(DF₂)*E(DF₂)/(1+exp((DF₁−a)/b))
or specifically as:
I(DF₁,DF₂)=H(DF₂)*E(DF₂)/(1+exp((DF₁−1.025)/0.0425))

HbA_{1c} is related to FPG. Two equations may be used, one for people with type 2 diabetes, and the other for people with type 1 diabetes. Both may follow the general formula:
HbA_{1c}(FPG)=a*FPG−b

For type 2 diabetes, the specific formula may be:
HbA_{1c}(FPG)=0.058*FPG−1.780

Randomly measured plasma glucose (RPG) is a function of a person's FPG, with a lot of uncertainty (Δ_{RPG}) and may be represented generally as follows
RPG(FPG)=(a+b/(1+exp(−(FPG−c)d)))*expΔ_{RPG}
or specifically as:
RPG(FPG)=(41.46+484.61/(1+exp(−(FPG−206.11)/56.44)))*expΔ_{RPG}

The two hour oral glucose tolerance test is affected by many biological variables. A regression equation may be used to estimate the true tolerance to an oral glucose load. A residual variance, the variance not explained by the variables in the regression equation, may be used to modify the regression equation. [While the minute-to-minute glucose level after a glucose load changes rapidly], a person's 2-hour value can be predicted from their FPG, age (t), BMI, systolic blood pressure (SBP) and triglyceride level (TRI), within known degrees of variability.
OGT(t)=a*FPG(t)+bt+cBMI(t)+dSBP(t)+eTRI(t)−f+VAR_{OGT}

This test usually involves taking a 75 g load of glucose after a fast, and then measuring the glucose level at various times thereafter, with 2 hours being used to measure the risk or presence of diabetes. This may be represented specifically as:

$$OGT ( t ) = 2.05 * FPG ( t ) + 0.42 t + 1.2 BMI ( t ) + \\ 0.055 SBP ( t ) + 0.025 TRI ( t ) - 119.7 + {VAR}_{OGT}$$

People with diabetes typically have higher blood pressures than people who do not have diabetes. This may be modeled by multiplying the patient's peripheral resistance by a factor, which may be termed the diabetes blood pressure factor (DiabBP). The factor DiabBP is a function of the diabetes features and therefore is higher for people with more severe diabetes. This may be represented generally as:
DiabBP=a exp(σ_{DiabBP})
or specifically as:
DiabBP=0.08exp(σ_{DiabBP})
Signs and Tests

The diabetes pathophysiology model currently includes tests for four biological variables: fasting, oral glucose tolerance, HbA_{1c}, and random blood glucose. In each case the result of the test is determined by the patient's true value of the biological variable, as calculated elsewhere in the model, and a random variable that reflects the observed variability and errors in test results. This may be expressed as follows.
FPGT(t)=FPG(t)*(exp(Δ_{FPG})),Δ_{FPG}=N(a,SD_{FPG})
Diagnosis

There is no clear biological line that defines diabetes. The American Diabetes Association (ADA) defines a person to have diabetes if either he or she has symptoms plus a casual plasma glucose greater than 199 mg/dl, or a random plasma glucose greater than 125 mg/dl, or an OGTT greater than 199 mg/dl. Impaired glucose tolerance is defined as the presence of both FPG less than 140 and OGTT between 140 and 200. Impaired fasting glucose (IFG) is defined as FPG between 110 and 126. The present invention is flexible to accommodate any definition. More specifically, the diabetes features do not determine the progression of a patient to a “state” called “diabetes”. Rather, the features determine the progression of the underlying biological phenomena that determine a person's glucose level at any time.

Symptoms

In an embodiment of the present invention, four symptoms are tracked. However, one of ordinary skill in the art will recognize that other symptoms may be used and/or added later. In this embodiment, thirst, polyuria, fatigue, and blurred vision are modeled. The approach to each symptom is similar. Using thirst as an example, there is a feature that represents the magnitude of a patient's thirst due to diabetes at any time. It is a function of the person's fasting plasma glucose and a randomly assigned factor for each person that represents the variation in thirst experienced by different individuals (the “thirst propensity”). In this embodiment, when a patient first experiences the symptom of thirst a message may be sent to the person's perception and stored in the person's memory. The person's perception multiplies the number of symptoms of that type by the intensity of the symptom. The person's perception does this for each type of symptom, and adds them together, and then compares that value to a “symptom threshold”, which is unique for each patient. If the sum of all the symptoms multiplied by their intensities exceeds the symptom threshold, the person may seek care.

The intensity of a person's thirst (Thirst) caused by diabetes is a function of their FPG, and varies from time to time (x).

$$Thirst ( x , FPG ( t ) ) = \frac{1}{\sqrt{2 π {SD}_{thirst}}} exp ( - \\ ( \frac{x - {MeanSym}_{thirst} ( FPG ( t ) )}{2 {SD}_{thirst}} ) )$$

SDₜₕᵢᵣₛₜ represents the standard deviation of the degree of thirst experienced by an individual. The probability of particular person will seek care for thirst (TH) is a function of the chance an average person with that FPG will seek care (MeanSymₜₕᵢᵣₛₜ), modified by that particular person's “thirst propensity” (σₜₕᵢᵣₛₜ)
TH(FPG(t))=σₜₕᵢᵣₛₜ+MeanSymₜₕᵢᵣₛₜ(FPG(t))

The fraction of people who seek care for symptoms at various levels of FPG can be estimated from existing data. This may be represented generally as:
MeanSym(FPG)=a*FPG^{1.5}+b*FPG²+c*FPG^{2.5}
and specifically as:
MeanSym(FPG)=0.00754*FPG^{1.5}+0.00103*FPG²+0.00003811*FPG²⁵
Health Outcomes of Glucose Metabolism

Two main acute health outcomes may be associated with diabetes metabolism: ketoacidosis and hypoglycemia. In an embodiment of the present invention, when intracellular glucose levels are low, the liver may attempt to correct for this by metabolizing fat into glucose, and ketones may be produced as a byproduct. This occurs almost exclusively in type 1 diabetes. The occurrence of diabetic ketoacidotic events (DKAₜᵢₘₑ) is a function of a person's “natural” (untreated) insulin level (I_{untreated}), in the absence of treatment. This may be represented generally as:
DKAₜᵢₘₑ=Max(a/(1+exp(I_{untreated}−b)/c)d)
or specifically as:
DKAₜᵢₘₑ=Max(100/(1+exp(I_{untreated}−0.4)/0.08) 20)

In an embodiment of the present invention, hypoglycemia can occur when a person's insulin amount is artificially raised, either by taking insulin or by taking an oral medication to enhance natural insulin production. The probability of a moderate or severe hypoglycemic event (HypoGlyRate) is a function of the fractional change in a person's insulin level (FractΔᵢₙₛᵤₗᵢₙ). The greater the proportional drop, the greater the chance of an event. This may be represented generally as:
HypoGlyRate(FractΔᵢₙₛᵤₗᵢₙ)=a/(1+exp^{-(FractΔ}^{ᵢₙₛᵤₗᵢₙ}^{-b)tc})
or specifically as:
HypoGlyRate(FractΔᵢₙₛᵤₗᵢₙ)=0.634/(1+exp^{-(Fract}^{ᵢₙₛᵤₗᵢₙ}^{-0.807)0.184})

For a particular individual, the time to the next event is:

In (ξ₄)/HypoGlyRate_{Ave}*(FractΔᵢₙₛᵤₗᵢₙ/I) where ξ₄ is chosen randomly from a uniform distribution once for each person and stored for that person.

In an embodiment of the present invention, hyperglycemia is included in the sense that it affects signs (e.g., glucosuria), symptoms (e.g., polydispia) and the complications of diabetes.

Treatments

In an embodiment of the present invention, three main types of treatment may be identified: insulin, oral drugs, and lifestyle. An insulin factor may be utilized, that determines the change in the insulin amount (I) caused by one unit of insulin per kilogram per day. To represent individual variations in response to insulin, the insulin factor for each person may be drawn from a distribution that reflects the degree of variation in the population.

A variety of drugs may be utilized by the present invention, all of which have different mechanisms of action. To illustrate how drugs are represented, two drugs with different mechanisms of action will be described: Glyburide and Metformin. Ultimately, both these drugs affect the FPG, although they appear to do so in different ways. Because Glyburide causes a person to produce more insulin, an embodiment of the present invention may represent it by causing the beta cells to increase the insulin amount by a factor, called the “Glyburide factor”. Because Metformin causes the liver to produce less glucose, an embodiment of the present invention may represent it by causing hepatic cells to decrease the production of glucose by a factor, called the “Metformin factor”, which in turns affects a person's reference FPG. Both these drugs therefore affect other equations utilized by an embodiment of the present invention. In addition to their effects of plasma glucose, both of these drugs affect other variables.

Changes in lifestyle such as diet and exercise may also affect certain parameters. One is a direct effect on the FPG, which may be represented through the hepatic production of glucose. Diet and exercise may also change lipid levels, blood pressure, and weight.

Complications

The full diabetes model may contain more than one hundred other biological variables, symptoms, tests, treatments, and outcomes relating to the complications of diabetes and their management. Briefly, coronary artery disease may be handled through two primary features called slow occlusion and fast occlusion. They correspond to the gradual formation of atherosclerotic plaque in coronary arteries, and to the sudden occlusion of a coronary artery due to rupture of plaque and/or development of an occlusive thrombus, respectively. In the model either of these types of occlusion can occur at any point in any of the four coronary arteries, with appropriate implications for the amount and part of the distal myocardium that is affected.

Both occlusion features may be features of time, as well as other features, and may take values ranging from 0 to 1. The clinical manifestation of a fast occlusion is a sudden blockage of the coronary artery (the formation of a thrombus) along with intense chest pain. Although the fast occlusion feature progresses continuously in time, its value can not be measured by any existing diagnostic tests until it actually blocks the artery, which is defined to occur when F=1.

The clinical manifestation of slow occlusion is a gradual occlusion or narrowing of the artery as occurs with the development of plaque. This type of occlusion can be measured with tests such as cardiac catheterization, and can cause signs (e.g., abnormal EKG readings) and symptoms (e.g., angina, chest pain, or coronary insufficiency). Based on data on the degree of occlusion seen on cardiac catheterizations done at the time of angina, it may be specified that chest pain will begin to occur when the slow occlusion feature is near 0.7. The actual value for any particular person would, of course, vary depending on the person's history of previous chest pains, medications, and other characteristics, as well as a random variable.

Both fast and slow occlusion can cause complete or nearly complete blockage of an artery and the death of surrounding heart muscle. The locations at which fast and slow occlusions first occur within each artery, and therefore the amount and location of myocardium that is affected, are determined by data on the locations of heart attacks and occlusive disease seen in clinical settings. To model the location of the first and subsequent heart attacks for any particular person, an order may be randomly assigned to the arteries for each person, for each type of occlusion. For any particular person, the progression of the occlusion features in the arteries selected as the first potential sites for those occlusions may be calculated. If an occlusive event of either type occurs in an artery, the progression of that occlusion feature in the next artery in the sequence may be calculated.

Equations for the two occlusion features can be derived from existing data on the rates of occurrence of various clinical events as functions of a person's age and other characteristics. The approach is similar for both features. Let h_{f} be the incidence rate of fast occlusions. Because this rate is a function of several biological variables and patient characteristics, as well as time, then h_{f} may be written as h_{f}(t,\overline{r}_{f}), where \overline{r}_{f} is a vector of risk factors for fast occlusion, some of which themselves are functions of time. Let H_{f}(t,\overline{r}_{f}) be the integral of the rate of fast occlusions over time. Thus H_{f}(t,\overline{r}_{f})=∫₀h_{f}(x,\overline{r}_{f}(x))dx, and the distribution for the time to a fast occlusion is given by 1−exp(−H_{f}(t,\overline{r}_{f})). The equation for the first episode of fast occlusion (i.e., a person's first heart attack) is:
F=(1−exp(−H_{f}(t,\overline{r}_{f})))/ξ_{f}

where a value of ξ_{f} is drawn for each person from a uniform distribution on the interval [0, 1]. This equation determines the age at which a fast occlusion event will occur in that artery in that person (including the possibility of never having a first heart attack). It also causes a collection of people to get first heart attacks due to fast occlusions at the same rates and ages as real people.

To estimate h_{f}(t,\overline{r}_{f}), regression equations may be used. These regression equations may calculate the n-year rates for six outcomes—CHD, MI, CHD death, stroke, CVD, and CVD death—as functions of a person's sex, age, systolic blood pressure (SBP), cigarette use (yes/no), the ratio of total cholesterol to HDL cholesterol (T-chol/HDL), presence of diabetes (yes, no), and indications of left ventricular hypertrophy on ECG (LVH). Because the equations are most accurate for lengths of times between 4 and 12 years, 8-year rates may be calculate, h₈(t,\overline{r}_{f}), and used in the equation h_{f}(t, \overline{r}_{f})=1n(1−h₈(t, \overline{r}_{f}))/8 to determine the needed one-year rates. Without treatment, the person's risk factors change with age at rates estimated from a general dataset. If any risk factors change because of treatment, those changes will be reflected in the above equation through the vector of patient characteristics, \overline{r}_{f}(t). Equations may also be used for MI (non-fatal) and CHD death (fatal MHI). An equation for sudden occlusion (fatal or non-fatal MI) from the equations for MI or CHD death may be derived as follows:
hₜₒₜₐₗ=hₘᵢ+h_{CHDdeath}−hₘᵢ*h_{CHDdeath}

In addition to the first sudden occlusion event in the first artery, people can also have evens in the other three arteries. Each artery is subject to its own fast occlusion feature. The equation for the progression of the feature is the same for each artery, but because the equation includes a random variable, ξ., the progression of the feature is different for each artery. The equation is:
F=F₀+(exp(−H_{f}(t₀,\overline{r}_{f}))−exp(−H_{f}(t,\overline{r}_{f}))/ξ.

where t₀ is the time of the previous event, and F₀ is the value of F at time t₀, and ξ. is drawn from a uniform distribution on [0,1]. Notice that the first occlusive event, t₀=1, h_{f}(t₀)=0, F(t₀)=0. When an event occurs in the first artery, the time of that event may be marked as t₀, F₀ is calculated for that time for each of the other arteries, and the equation is reset and used to calculate the progression of the fast occlusion feature from that point on, for each artery. The model also allows for second occlusions to occur in an artery that has already had one occlusion, in a part of the artery proximal to the original occlusion. For this, the equation may be used, with F₀ chosen to reproduce the rate of repeat occlusions seen in clinical trials.

The slow occlusion feature may be address in a similar fashion. The general equation may be:
S=S₀+(exp(−Hₛ(t₀,\overline{r}ₛ))−exp(−Hₛ(t,\overline{r}ₛ))/ξₛ

where Hₛ(t,\overline{r}ₛ) is the integral of the incidence rate of slow occlusion events, hₛ(t,\overline{r}ₛ) and ξₛ is drawn from a uniform distribution on [0,1]. Recall that the slow occlusion feature, S, must be scaled so that S=0.7 when angina first occurs, and S=1 when the occlusion becomes 100% and causes the infarction. The regression equations described above may be used to estimate an equation for the function Hₛ(t,\overline{r}ₛ) that will accomplish this. The first step is to get an equation for the annual incidence of angina. A general study may be used for equations for total occlusions and for CHD, which includes both total occlusion and angina. Because the slow occlusion feature is intended to determine the occurrence of angina, an equation may be derived for it by “subtracting” the equation for occlusion from the regression equation for CHD, symbolically,
h_{angina}=Max((h_{chd}−hₜₒₜₐₗ)/(1−hₜₒₜₐₗ),0)

The next step is to define the S function so that it has the value 0.7 when a person begins to experience angina, on average. This may be accomplished by defining S for the first occurrence of angina as S=0.7*(1−exp(−H_{angina}(t,\overline{r}ₛ))/ξₛ, where H_{angina}(t,\overline{r}ₛ)=∫₀h_{angina}(x,\overline{r}ₛ)dx. The third step is to derive an equation for H_{S} in terms of H_{angina} so that the equation S=(1−exp(−Hₛ(t,\overline{r}ₛ)))/ξₛ is satisfied. This occurs if H=0.7*H_{angina}/(0.3*H_{angina}+0.7).

In the regression equations, one of the risk factors in the vectors of patient characteristics \overline{r}_{f} and \overline{r}ₛ is a dichotomous variable that represents the presence or absence of diabetes (called “DM”). The inclusion of diabetes as a dichotomous variable in the regression equation does not take into account such things as the duration or severity of diabetes or the response to treatment, all of which are in this model. To incorporate them, a formula for DM may be derived as a function of the two features DF₁ and DF₂ and the persons FPG. All three of these are functions of time and a variety of other factors. The equation is
DM=0.4*(a/(1+exp(−(DF−b)/c))+0.6*(a/(1+exp(−(FPG−d)/e))−0.53
where DF=DF₁+DF₂. The first term, which is a function of DF₁ incorporates the duration and severity of the disease, and all of the patient characteristics that affect the diabetes feature. The second term incorporates the degree of control of the disease over time, as registered in the variable FPG. Because both terms are functions of time, this formulation captures both the instantaneous values of these variables and the historical course of the disease over time. The parameters a, b, c, d, and e in this equation are different for males and females. For example, for males a=2.5246, b=0.90185, c=0.09489, d=126.113, e=9.6629, while for females, a=1/3696, b=0.88062, c=0.08135, d=123.935, e=8.4748.

Strokes may be represented through four features: hemorrhagic occlusion (HO), ischemic occlusion (IO), hemorrhagic stroke death (HD), and ischemic stroke death (ID). Hemorrhagic and ischemic stroke are represented separately because they have very different etiologies, health outcomes, costs, treatments, and death rates. For either type of stroke, the occurrence of a stroke is determined by the occlusion features. After the stroke occurs, the probability and time of death may be determined by the death features. As with coronary artery disease, a person can have multiple strokes. To model this, for each person and for each type of occlusion the cerebral arteries may be randomly assigned an order. The progression of the occlusion features in the arteries selected as the first potential sites for those occlusions may then be calculated. If an occlusive event of either type occurs in an artery, and the person survives the stroke, then the progression of that occlusion feature is calculated in the next artery in the sequence.

The equations for the first occurrence of an occlusive event may be illustrated by the hemorrhagic occlusion feature. The general form is:
HO(t)=1−exp(−Hₕₒ(t))/ξₕₒ
where Hₕₒ(t)=∫₀hₕₒ(x)dx and hₕₒ(t) is the incidence rate of first hemorrhagic strokes. As usual, a value of ^{ξ}^{ₕₒ} may be drawn for each person from a uniform distribution on the interval [0,1]. The occlusion feature may be scaled so that a stroke occurs when HO=1. Once a hemorrhagic stroke occurs, the hemorrhagic stroke death feature may be used to calculate the probability of dying of the stroke as a function of time since the occurrence of the stroke. Its equation is:
HD(t)=(1−exp(−(H_{hd}(t)−H_{hd}(t₀))))/ε_{hd}
where H_{hd}(t) is the cumulative probability of death following a hemorrhagic stroke, ε_{hd} is drawn from a uniform distribution, and to is the time (age) of the stroke.

If a person survives the first stroke, then the occurrence of the next stroke at the next site may be determined by the following equation:
HO(t)=HO₀+(exp(−H_{hd}(t₀))−exp(−H_{hd}(t))/εₕₒ

For this equation, t₀ is set to the time of the previous stroke, HO₀ is set to the value fo the next largest occlusion in a cerebral artery (the next artery in line to have an occlusive event) and a new value of ξₕₒ is drawn. This can be repeated for additional strokes. Ischemic occlusions may be handled in the same way.

Equations for the incidence rates of strokes may be derived from existing data. The equations may include the following risk factors: sex, age, systolic blood pressure, diabetes, smoking, cardiovascular disease, and atrial fibrillation. To these we add race, through a multiplicative factor (relative risk). The existing equation applies to any type of stroke. Based on data on the frequencies of different types of strokes, it may be specified that 20% of strokes are hemorrhagic and 80% are ischemic.

For the stroke death features, there is data on the cumulative probability of death following a stroke for a person of age t as a function of time since the stroke, t_{S}. From this we derive a distribution for t_{S} and, for any given person who just had a stroke, a probability of death from the stroke and an age at which that death will occur, which may be called P_{strokedeath}(t,t_{S}). From the available data, the equation for P_{strokedeath}(t,t_{S}) is:
P_{strokedeath}(t,tₛ)=A(t)*tₛ^{B(t)}
where A(t)=a₁+a₂/(1+exp(−(t−a₃)/a₄)) and B(t)=b₁+b₂/(1+exp(−(t−b₃)/b₄)). The equation for deaths following a second or later stroke is:
P_{2+strokedeath}(t,tₛ)=(A(t)*tₛ^{B(t)})*(p*t+q)

This information does not allow for the effects of any risk factors or acute treatments. Since there may not be data on this, as a first order approximation, it may be assumed that deaths from strokes are affected by the same risk factors that affect the occurrence of strokes in the first place. This approach enables the probability and timing of death from strokes to be modified by changing a risk factor, such as systolic blood pressure. If the person has a second stroke, the distribution for death following a second stroke may be used and the procedure repeated. Currently, if a person has a 4th stroke, it may be assumed that he or she dies. The risk factors for CVD and atrial fibrillation come from the heart model. The risk factor for diabetes may be applied as a continuous function and may come from the diabetes mode, as described for coronary artery disease. Ischemic strokes may be handled in a similar way.

Turning to retinopathy, clinically retinopathy is a complex condition manifested by a variety of ophthalmologic signs (e.g. hemorrhages, microaneurisms, hard and soft exudates, new vessels, fibrous proliferation, and macular edema), as well as symptoms (e.g. spotty vision, flashing lights, cloudy vision, and loss of visual acuity). Various classification systems have been developed for scaling the progression and severity of retinopathy in terms of these signs and symptoms. Currently, the most commonly used system is one developed for the Early Treatment Diabetic Retinopathy Study (ETDRS). This scheme relates various combinations of sign and symptoms to a numerical scale that ranges from 0 to 80. It also breaks the scale into discrete “steps”, which are used to designate the progression of the disease and its response to treatments (e.g. “two-step progression”, “three-step progression”).

The modeling task is to represent a person's progression through the ETDRS classification system in a way that recreates the rate of progress and response to treatments seen in clinical trials. This may be begun by defining a “retinopathy feature” (RF) whose values will map to the ETDRS scale. The scale for the RF feature in the model was chosen to correspond to the “steps” that have been defined for the ETDRS scale, with each integer in the RF scale corresponding to the cut-off values that define what are called “two-step” progressions in the ETDRS scale. For example, on the ETDRS scale a person who begins with levels of 0 in both eyes and progresses to levels of 21 in both eyes is said to have made a two-step progression on the ETDRS scale. Using the retinopathy feature, such a person would have progressed from RF=0 to RF=1. In general, a “three-step” progression on the ETDRS scale corresponds to an increase in RF of 1.5 points.

The form of the equation for RF may be similar to the forms of the equations for the incidence of type 1 and type 1 two diabetes, and for the incidence of heart attacks. It is
RF=(1−exp(−∫₀q(x)dx))/ξᵣ,
where the ξᵣ is drawn from a uniform distribution on [0,1] and q(t) is rate of retinopathy progression. As before, the form of this equation causes people to reach various stages of retinopathy at times that correspond to the times observed in clinical trials. The key to the equation is q(t), which is based on data on the rates of two-step and three-step progression as functions of time, with and without treatment, in clinical trials of type 1 and type 2 diabetes.

$$q ( t ) = 0.243 / ( 1 + exp ( - ( ( FPG - 109 ) - \\ 132.70083 ) / 18.606963 ) ) * ( 1 + 0.033 * ( SBP - 144 ) ) * \\ ( 1 + 0.6 / ( 1 + exp ( - ( GL - 1000 ) / 100 ) ) ) * \\ Max ( Min ( 1.7 , 4.97 * FPG / ( GL + 1 ) ) , 0.8 )$$

This equation has four parts. One addresses the independent effect of FPG, another addresses the independent effect of blood pressure (SBP). A third addresses the effect of what is called the “glucose load” (GL), which is the integral of the degree to which a person's glucose level is abnormal.

Specifically, ^{GL=∫}^{₀}^{(FPG(x)-120)dx}. The fourth term registers the joint effect of GL and FPG.

In this model, the occurrence and progression of nephropathy may be controlled by a feature called the nephropathy feature (NF). The equation for the nephropathy feature has three parts, corresponding to the three successive stages of the disease that are distinguished clinically (and for which incidence rates are recorded). They are called “albuminuria”, “proteinuria” and “renal disease”. The general form of the equation for NF

$$NF = ( 1 - exp ( - albumin ) ) / {ξ}_{albumin} + \\ ( 1 - exp ( - protein ) ) / {ξ}_{protein} + 3 * ( 1 - exp ( - renal ) ) / {ξ}_{renal}$$

Each of the pieces of the equation—albumin, protein, renal—has the same form, which is shown here for albumin
albumin=∫₀albuminrate(t′)dt′

In general, the variables “albuminrate”, “proteinrate” and “renalrate” register the incidence rates of each stage in people who are in the previous stage. This may be implemented by “turning on” the parts of the equation in succession, to represent the passage of a patient through each stage. Thus to start the calculations (at t=0, or birth), proteinrate and renalrate are set to zero, and albuminrate is set to

$$albuminrate = ( ( 0.42 / ( 1 + exp ( - ( FPG - 165 ) / 8.993 ) ) + \\ 0.08 / ( 1 + exp ( - ( gl - 1200 / 100 ) ) ) * \\ ( 1 + 0.033 * max ( ( SBP - 144 ) , 0 ) ) * ( 1.0024879 + \\ 1.2623371 / ( 1 + ( FPG / 192.67738 ) \hat{} \\ ( - 17.303872 ) ) * ( 1 / ( 1 + exp ( - ( GL - 1200 ) / 50 ) ) )$$

for type 1 diabetes, and to

$$albuminrate = ( 0.0132 / ( 1 + exp ( - ( FPG - 170 ) / 5.401 ) ) + \\ 0.003679775 * {( min ( GL / 600 , 2.5 ) )}^{4} * ( 1 + 0.033 * \\ ( max ( sbp - 144 ) , 0 ) )$$

for type 2 diabetes. Both of these are derived from data on the incidence of albuminuria in patients with newly diagnosed type 1 and type 2 diabetes, respectively, as functions or FPG and systolic blood pressure (SBP). As before, GL is the glycemic load. The nephropathy feature is scaled such that clinical albuminuria begins to occur when ^{NF=1}. At that time albuminrate is set to zero (which sets the albumin part of the equation for NF to 1), and proteinrate is set to the following.

$$proteinrate = ( 0.011823 / ( 1 + exp ( - ( FPG - 170 ) / 5.401 ) ) + \\ 0.0008249185 * ( min ( GL / 600 , 1.5 ) \hat{} 3 ) * \\ ( 1 + 0.033 * max ( sbp - 144 , 0 ) )$$

for type 1 diabetes and

$$proteinrate = ( 0.01179 / ( 1 + exp ( - ( FPG - 170 ) / 5.401 ) ) + \\ 0.001374864 * ( min ( GL / 600 , 2.5 ) \hat{} 4 ) * ( 1 + 0.033 * \\ max ( sbp - 144 , 0 ) ) * ( 0.6 + 3.0 / ( 1 + exp ( - \\ ( GL - 1800 ) ) )$$

for type 2 diabetes.

When the kidney progression function reaches the value 2, the proteinrate may be set to zero (which sets the sum of the albumin and protein parts to the value 2), and renalrate is set to
renalrate=0.2*(1+0.25*max((sbp−144).0)

The clinical manifestations of nephropathy at any time may be determined by the value of the nephropathy feature at that time. For example, the amount of protein in the urine is determined by

$$urineprotein = \{ \begin{matrix}50 * {NF}^{2.58} & for NF < 2.0028 \\ 3494.27 * ( 1 - EXP ( - ( NF - 2.0028 ) * 2.933 & for NF \geq 2.0028\end{matrix}$$

Another important measure of renal disease, creatinine, is given by

$$creatinine = \{ \begin{matrix}1.00209 * weightfactor & for NF \leq 2.0028 \\ 1.0209 / ( 1 - ( 0.296493 * ( NF - 2.00277 ) ) ) & for 2.00277 < NF < 5.75106 \\ 11.25 * weightfactor & for NF \geq 5.75106\end{matrix}$$

where ^{weightfactor=0.078509+(weight/averageweight)}^{^{0.664751}} and the average weight for females is 64 kg, and for males is 79.2 kg. A person begins to develop symptoms of end stage renal disease (ESRD) when the creatinine level reaches 7.6. ESRD is advanced when creatinine levels approach 9.

The effects of diabetes may be modeled using two features, a sensation feature, SF, and an ulcer feature, UF. The former determines the loss of sensation, the latter determines the occurrence of skin ulcers and their complications. Two feature are needed because these two types of complications have different incidences and rates of progression. The form of the sensation feature may be:
SF(t)=(1−exp(−S(t)))/ξₛ
where ^{S(t)} is the integral of the incidence rates of symptoms of loss of sensation, ^{S(t)=∫}^{₀}^{s(x)dx}, and the incidence rate is given by
s(t)=ΔF/(53.8671*ΔF−193.328*\sqrt{ΔF+280.301})
and ^{ΔF(t)=max(0.3153*FPG(t)-2.965,0)}.

The equations for the ulcer feature may have a similar form and derivation.
UF(t)=(1−exp(−U(t)))/ξᵤ
where

$$U ( t ) = {\int }_{0}^{t} u ( x ) ⅆ x ,$$

^{u(t)=ΔF}^{^{1.5}}^{/(44.208*ΔF}^{^{1.5}}^{-7.70592*ΔF}^{²}^{+218.668)}, and ^{ΔF(t)} is defined as above.

The signs and symptoms of neuropathy are related to these features. For example, a person will have a positive Semmes Weinstein 20 gm test when the SF feature is approximately 0.7. A person will begin to have experience a loss of sensation when the SF feature reaches 0.8. A person will test positive on the Semmes-Weinstein 10 gm test when the SF feature is approximately 1. Regarding ulcers, a person will have the first symptoms of foot sores when the UF feature is about 0.8. Examination by a podiatrist will reveal more severe foot problems at higher values of UF. The scale is; foot deformities appear at UF=0.72; foot calluses at UF=0.86; foot scrapes at UF=1; foot wounds at UF=2; draining wounds at UF=3; gangrene at UF=3.8; visible gangrene at UF=3.9; and severe gangrene at UF=4.

The model may contain several other parts that are not described here, but that are needed for a complete analysis, or to simulate a clinical trial for a validation. They include: methods for creating populations that have the same marginal distributions of characteristics as real populations, such as the NHANES population; models of acute events such as myocardial infarctions and strokes; models of the tests and treatments pertinent to the complications of diabetes; models of congestive heart failure and asthma; models of patient and physician behaviors; models of care processes and logistics; and models of system resources such as facilities, personnel, equipment and supplies.

Care Processes

In an embodiment of the present invention, the processes of care may be handled in the form of algorithms. They describe what providers do in specific circumstances. For example, an algorithm for the control of cholesterol in a patient with diabetes might say: “If the patient's LDL cholesterol is greater than 180 and their creatinine is less than 2, then give Lovastatin 80 mg. At 2 months, have the patient get a lipid panel and creatinine test. At that time if the LDL is not below 130 and the creatinine is still below 2, then switch to Simvastatin 80 mg . . . ” and so forth. Care processes can vary from setting to setting and even from physician to physician. The algorithms can also include variations in practice styles, uncertainty, and random factors; can depend on the type of provider (e.g., specialist vs. primary care physician); and can depend on other factors (e.g., attendance of a particular CME course, or access to a clinical information system with reminders).

System Resources

In an embodiment of the present invention, system resources such as personnel, facilities, equipment, and supplies needed to deliver care may be included at a high level of detail. For example, there may be 37 different types of office visits. Use of these resources may be triggered whenever patients encounter the system or an intervention is applied. Each and every resource and its associated time and cost may be tracked for every patient.

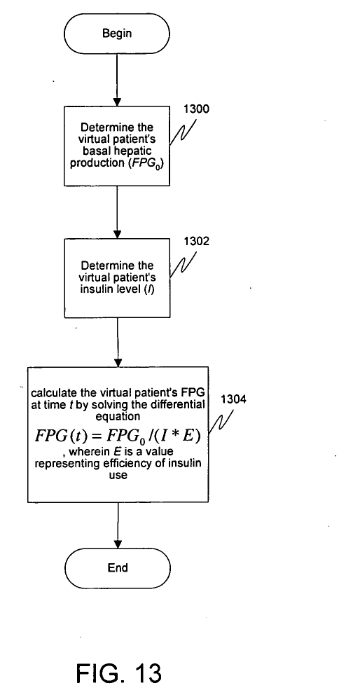

FIG. 13 is a flow diagram illustrating a method for estimating a virtual patient's fasting plasma glucose (FPG) level in accordance with an embodiment of the present invention. At 1300, the virtual patient's basal hepatic production (FPG₀) may be determined. In type 2 diabetes this may include solving the differential equation FPG₀ (t)=G(t)*H(DF₂ (t)), wherein G(t) is the degree of insulin resistance in a person with diabetes (H). In type 1 diabetes this may include solving the differential equation FPG₀ (t)=G(t)*H(DF₁(t)), wherein G(t) is the degree of insulin resistance in a person with diabetes (H). For either of these:
H(DF₂(t))=1/(MAX [E²(DF₂(t+a)), b]) and
G(t)=(a+bt^{1.5}−c*t³+Δ_{g})/(d−eexp(−DF₂(t)ξ₂)), wherein Δ_{g} represents a variance of basal hepatic production across individuals.

At 1302, the virtual patient's insulin level (I) may be determined. At 1304, the virtual patient's FPG at time t may be calculated by solving the differential equation FPG(t)=FPG₀/(I*E), wherein E is a value representing efficiency of insulin use. E may be scaled such that E=1 in the absence of diabetes and 0≦E≦1 in the presence of diabetes. For type 2 diabetes, a differential equation representing E is:

$$E ( {DF}_{2} ) = {( a + b / ( 1 + {( {DF}_{2} / c )}^{d} ) )}^{\frac{1}{2}} ,$$

wherein DF₂ is a type 2 diabetes feature and

$$\begin{matrix}{DF}_{2} ( t ) = ( 1 - exp ( - a * IGT ( {ξ}_{3} ) / ( 1 + exp ( - \frac{( t - b )}{c} ) ) ) ) * \\ RBMI ( BMI ) / {ξ}_{2} ,\end{matrix}$$

wherein a, b, and c are constants, IGT is an impaired glucose tolerance value, and RBMI is the relative risk associated with a person's body mass index (BMI). The RBMI is represented by:
RBMI(BMI)=a+b/(1+e^{-(BMI-c)/d})

IGT is represented by:
IGT(ξ₃)=2(1−ξ₃)

wherein ξ₃ is a random value designed to cause the occurrence of diabetes in virtual patients to have the same types of interpersonal variations that occur in real people and
I(DF₁,DF₂)=H(DF₂)*E(DF₂)/(1+exp((DF₁−a)/b))

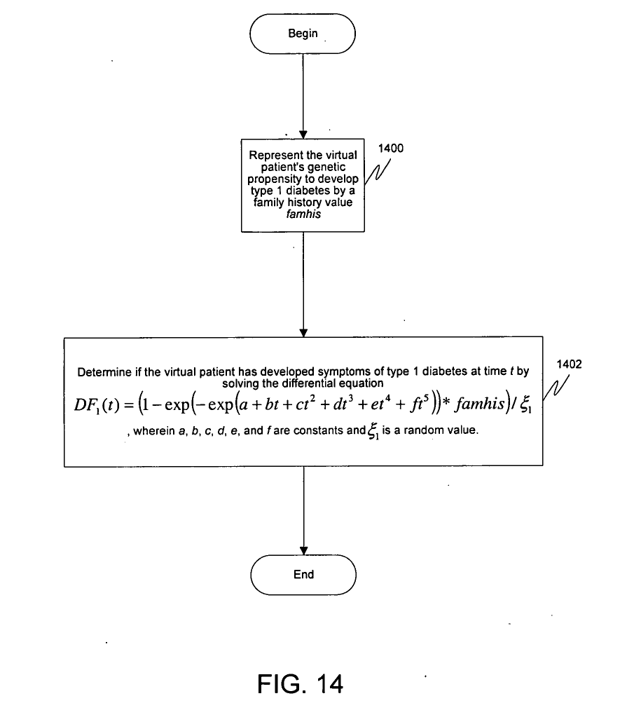

FIG. 14 is a flow diagram illustrating a method for estimating if a virtual patient has developed symptoms of type 1 diabetes in accordance with an embodiment of the present invention. At 1400, the virtual patient's genetic propensity to develop type 1 diabetes may be represented by a family history value famhis. At 1402, whether or not the virtual patient has developed symptoms of type 1 diabetes at time t may be determined by solving the differential equation DF₁(t)=(1−exp(−exp(a+bt+ct²+dt³+et⁴+ft⁵))*famhis)/ξ₁, wherein a, b, c, d, e, and f are constants and ξ₁ is a random value.

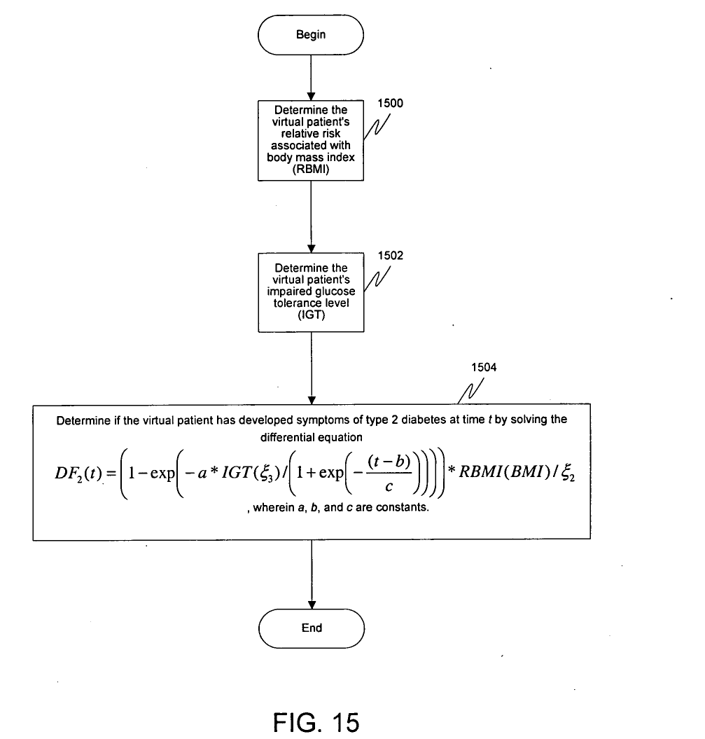

FIG. 15 is a flow diagram illustrating a method for estimating if a virtual patient has developed symptoms of type 2 diabetes in accordance with an embodiment of the present invention. At 1500, the virtual patient's relative risk associated with body mass index (RBMI) may be determined. At 1502, the virtual patient's impaired glucose tolerance level (IGT) may be determined. At 1504, whether or not the virtual patient has developed symptoms of type 2 diabetes at time t may be determined by solving the differential equation

$$\begin{matrix}{DF}_{2} ( t ) = ( 1 - exp ( - a * IGT ( {ξ}_{3} ) / ( 1 + exp ( - \frac{( t - b )}{c} ) ) ) ) * \\ RBMI ( BMI ) / {ξ}_{2} ,\end{matrix}$$

wherein a, b, and c are constants.

The RBMI may be represented by: RBMI(BMI)=a+b/(1+e^{-(BMI-c)/d}), wherein BMI is the virtual patient's body mass index.

IGT may be represented by:
IGT(ξ₃)=2(1−3),
wherein ξ₃ is a random value.

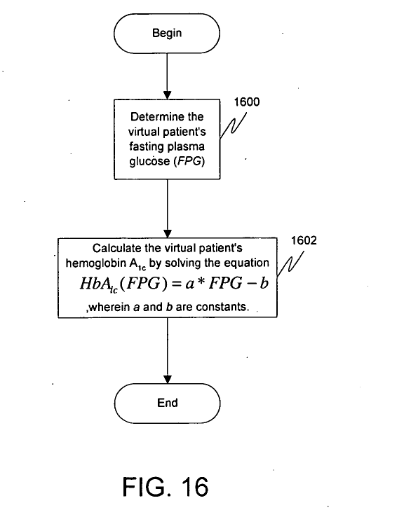

FIG. 16 is a flow diagram illustrating a method for estimating a virtual patient's hemoglobin A_{1c}(HbA_{1c}) in accordance with an embodiment of the present invention. At 1600, the virtual patient's fasting plasma glucose (FPG) may be determined. This is described in more detail in FIG. 13 and the accompanying text. At 1602, the virtual patient's hemoglobin A_{1c} may be calculated by solving the equation HbA_{1c}(FPG)=a*FPG−b, wherein a and b are constants.

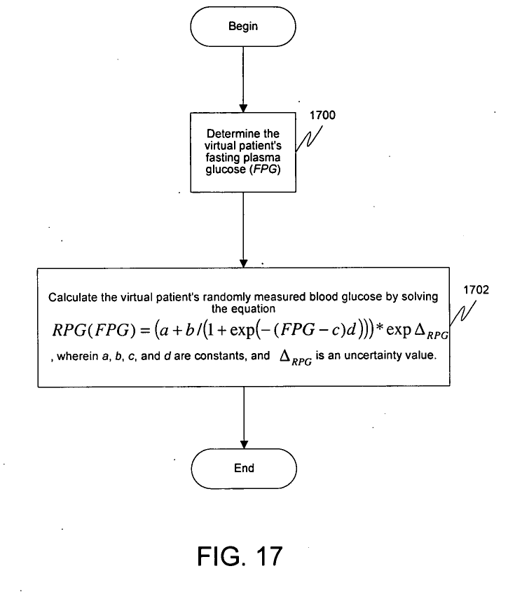

FIG. 17 is a flow diagram illustrating a method for estimating a virtual patient's randomly measured blood glucose (RPG) in accordance with an embodiment of the present invention. At 1700, the virtual patient's fasting plasma glucose (FPG) may be determined. This is described in more detail in FIG. 13 and the accompanying text. At 1702, the virtual patient's randomly measured blood glucose may be calculated by solving the equation RPG(FPG)=(a+b/(1+exp(−(FPG−c)d)))*exp Δ_{RPG}, wherein a, b, c, and d are constants, and Δ_{RPG} is an uncertainty value.

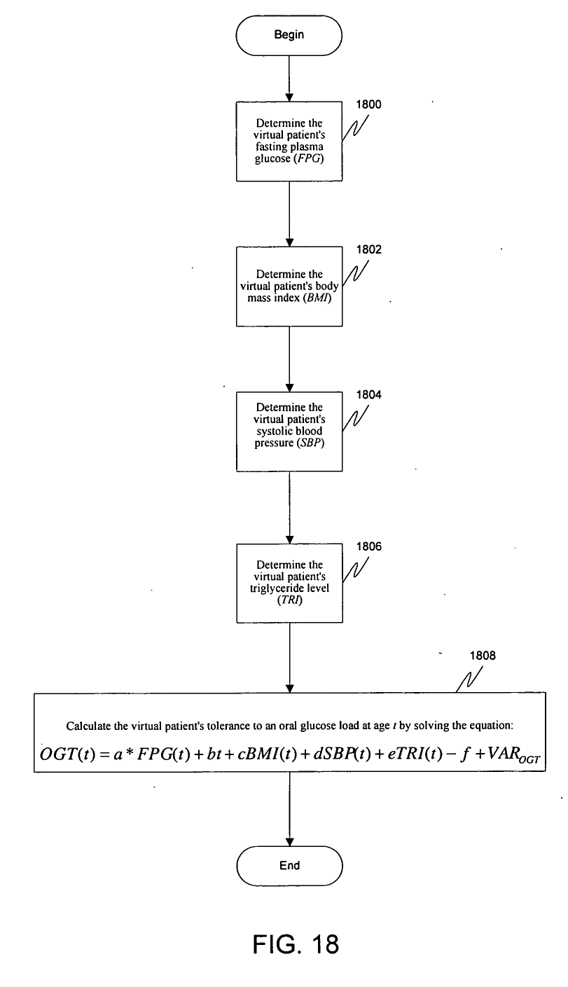

FIG. 18 is a flow diagram illustrating a method for estimating a virtual patient's tolerance to an oral glucose load at age t in accordance with an embodiment of the present invention. At 1800, the virtual patient's fasting plasma glucose (FPG) may be determined. This is describe in more detail in FIG. 13 and the accompanying text. At 1802, the virtual patient's body mass index (BMI) may be determined. At 1804, the virtual patient's systolic blood pressure (SBP) may be determined. Determining the virtual patient's SBP may include multiplying a peripheral resistance for the virtual patient by a diabetes blood pressure factor (DiabBP), which is a function of a diabetes feature and higher for people with more severe diabetes. At 1806, the virtual patient's triglyceride level (TRI) may be determined. At 1808, the virtual patient's tolerance to an oral glucose load at age t may be calculated by solving the equation:
OGT(t)=a*FPG(t)+bt+cBMI(t)+dSBP(t)+eTRI(t)−f+VAR_{OGT}.

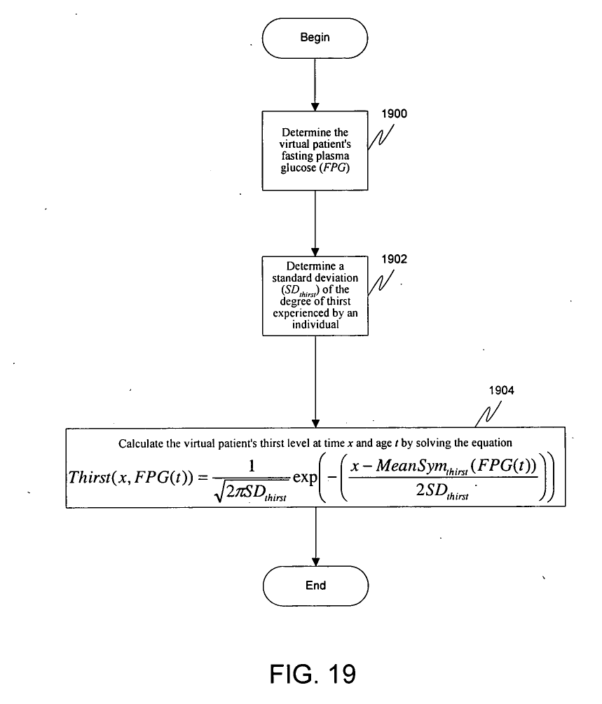

FIG. 19 is a flow diagram illustrating a method for estimating a virtual patient's thirst level at time x in accordance with an embodiment of the present invention. At 1900, the virtual patient's fasting plasma glucose (FPG) may be determined. This is described in more detail in FIG. 13 and the accompanying text. At 1902, a standard deviation (SDₜₕᵢᵣₛₜ) of the degree of thirst experienced by an individual may be determined. At 1904, the virtual patient's thirst level at time x and age t may be calculated by solving the equation

$$\begin{matrix}Thirst ( x , \\ FPG ( t ) )\end{matrix} = \frac{1}{\sqrt{2 π {SD}_{thirst}}} exp ( - ( \frac{x - {MeanSym}_{thirst} ( FPG ( t ) )}{2 {SD}_{thirst}} ) ) .$$

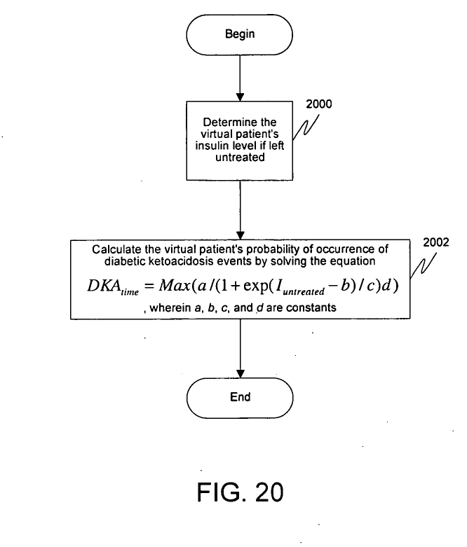

FIG. 20 is a flow diagram illustrating a method for estimating the probability of occurrence of diabetic ketoacidosis events (DKAₜᵢₘₑ) for a virtual patient in accordance with an embodiment of the present invention. At 2000, the virtual patient's insulin level if left untreated may be determined. At 2002, the virtual patient's probability of occurrence of diabetic ketoacidosis events may be calculated by solving the equation DKAₜᵢₘₑ=Max(a/(1+exp(I_{untreated}−b)/c)d), wherein a, b, c, and d are constants.

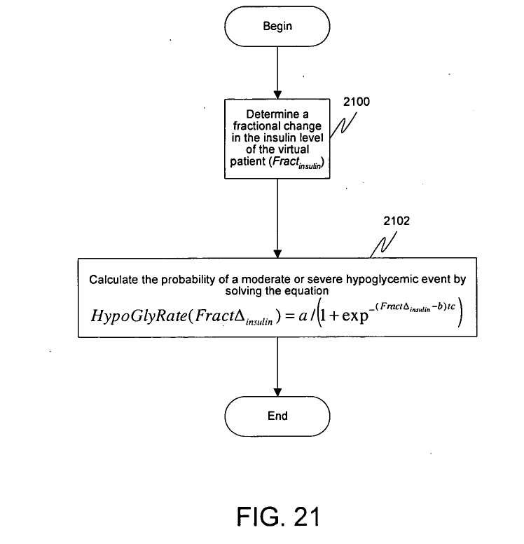

FIG. 21 is a flow diagram illustrating a method for estimating the probability of a moderate or severe hypoglycemic event (HypoGlyRate) in a virtual patient in accordance with an embodiment of the present invention. At 2100, a fractional change in the insulin level of the virtual patient (FractΔᵢₙₛᵤₗᵢₙ) may be determined. At 2102, the probability of a moderate or severe hypoglycemic event may be calculated by solving the equation
HypoGlyRate(FractΔᵢₙₛᵤₗᵢₙ)=a/(1+exp^{-(FractΔ}^{ᵢₙₛᵤₗᵢₙ}^{-b)tc}).

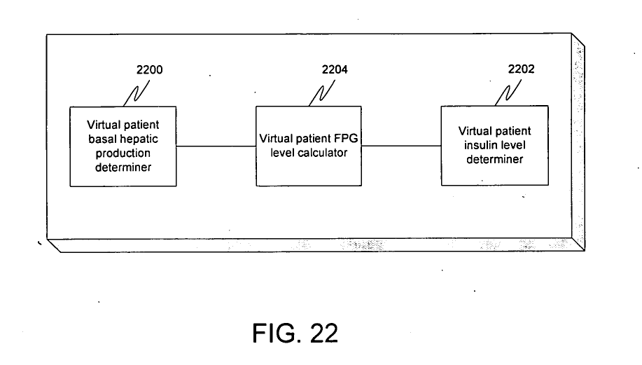

FIG. 22 is a block diagram illustrating an apparatus for estimating a virtual patient's fasting plasma glucose (FPG) level in accordance with an embodiment of the present invention. A virtual patient basal hepatic production determiner 2200 may determine the virtual patient's basal hepatic production (FPG₀). In type 2 diabetes this may include solving the differential equation FPG₀(t)=G(t)*H(DF₂(t)), wherein G(t) is the degree of insulin resistance in a person with diabetes (H). In type 1 diabetes this may include solving the differential equation FPG₀(t)=G(t)*H(DF₁(t)), wherein G(t) is the degree of insulin resistance in a person with diabetes (H). For either of these:
H(DF₂(t))=1/(MAX[E²(DF₂(t+a)),b]) and
g(t)=(a+bt^{1.5}−c*t³+Δ_{g})/(d−eexp(−DF₂(t)ξ₂)), wherein Δ_{g} represents a variance of basal hepatic production across individuals.

A virtual patient insulin level determiner 2202 may determine the virtual patient's insulin level (I). A virtual patient FPG calculator 2204 coupled to the virtual patient basal hepatic production determiner 2200 and to the virtual patient insulin level determiner 2202 may calculate the virtual patient's FPG at time t by solving the differential equation FPG(t)=FPG₀/(I*E), wherein E is a value representing efficiency of insulin use. E may be scaled such that E=1 in the absence of diabetes and 0≦E≦1 in the presence of diabetes. For type 2 diabetes, a differential equation representing E is:

$$E ( {DF}_{2} ) = {( a + b / ( 1 + {( {DF}_{2} / c )}^{d} ) )}^{\frac{1}{2}} ,$$

wherein DF₂ is a type 2 diabetes feature and

$$\begin{matrix}{DF}_{2} ( t ) = ( 1 - exp ( - a * IGT ( {ξ}_{3} ) / ( 1 + exp ( - \frac{( t - b )}{c} ) ) ) ) * \\ RBMI ( BMI ) / {ξ}_{2} ,\end{matrix}$$

wherein a, b, and c are constants, IGT is an impaired glucose tolerance value, and RBMI is the relative risk associated with a person's body mass index (BMI). The RBMI is represented by:
RBMI(BMI)=a+b/(1+e^{-(BMI-c)/d}).

IGT is represented by:
IGT(ξ₃)=2(1−ξ₃),

wherein ξ₃ is a random value designed to cause the occurrence of diabetes in virtual patients to have the same types of interpersonal variations that occur in real people. and
I(DF₁, DF₂)=H(DF₂)*E(DF₂)/(1+exp((DF₁−a)/b))

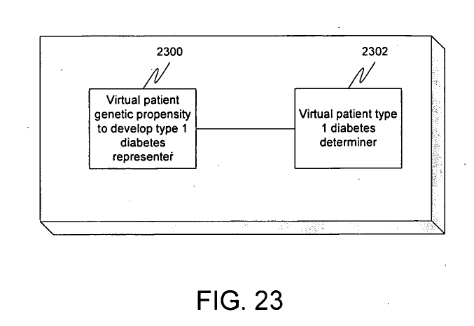

FIG. 23 is a block diagram illustrating an apparatus for estimating if a virtual patient has developed symptoms of type 1 diabetes in accordance with an embodiment of the present invention. A virtual patient genetic propensity to develop type 1 diabetes representer 2300 may represent the virtual patient's genetic propensity to develop type 1 diabetes by a family history value famhis. A virtual patient type 1 diabetes determiner 2302 coupled to the virtual patient genetic propensity to develop type 1 diabetes representer 2300 may determine whether or not the virtual patient has developed symptoms of type 1 diabetes at time t by solving the differential equation DF₁(t)=(1−exp(−exp(a+bt+ct²+dt³+et⁴+ft⁵))*famhis)/ξ₁, wherein a, b, c, d, e, and f are constants and ξ₁ is a random value.

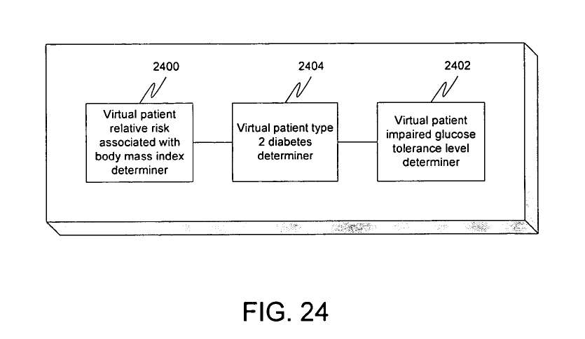

FIG. 24 is a block diagram illustrating an apparatus for estimating if a virtual patient has developed symptoms of type 2 diabetes in accordance with an embodiment of the present invention. A virtual patient relative risk associated with body mass index determiner 2400 may determine the virtual patient's relative risk associated with body mass index (RBMI). A virtual patient impaired glucose tolerance level determiner 2402 may determine the virtual patient's impaired glucose tolerance level (IGT). A virtual patient type 2 diabetes determiner 2404 coupled to the virtual patient relative risk associated with body mass index determiner 2400 and to the virtual patient impaired glucose tolerance level determiner 2402 may determine whether or not the virtual patient has developed symptoms of type 2 diabetes at time t by solving the differential equation

$$\begin{matrix}{DF}_{2} ( t ) = ( 1 - exp ( - a * IGT ( {ξ}_{3} ) / ( 1 + exp ( - \frac{( t - b )}{c} ) ) ) ) * \\ RBMI ( BMI ) / {ξ}_{2} ,\end{matrix}$$

wherein a, b, and c are constants.

The RBMI may be represented by: RBMI(BMI)=a+b/(1+e^{-(BMI-c)/d}), wherein BMI is the virtual patient's body mass index.

IGT may be represented by:
IGT(ξ₃)=2(1−ξ₃),
wherein ξ₃ is a random value.

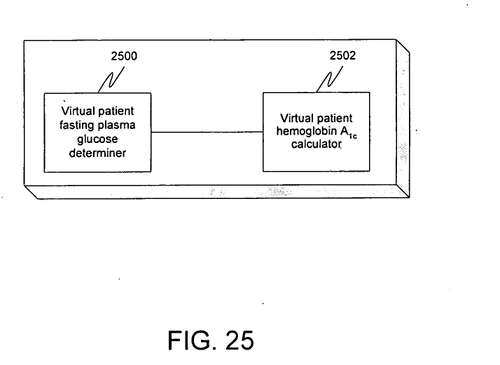

FIG. 25 is a block diagram illustrating an apparatus for estimating a virtual patient's hemoglobin A_{1c} (HbA_{1c}) in accordance with an embodiment of the present invention. A virtual patient fasting plasma glucose determiner 2500 may determine the virtual patient's fasting plasma glucose (FPG). This is described in more detail in FIG. 22 and the accompanying text. A virtual patient hemoglobin A_{1c} calculator 2502 coupled to the virtual patient fasting plasma glucose determiner 2500 may calculate the virtual patient's hemoglobin A_{1c} by solving the equation HbA_{1c} (FPG)=a*FPG−b, wherein a and b are constants.

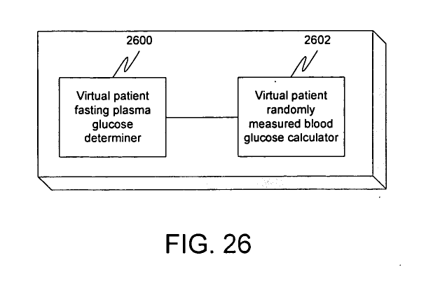

FIG. 26 is a block diagram illustrating an apparatus for estimating a virtual patient's randomly measured blood glucose (RPG) in accordance with an embodiment of the present invention. A virtual patient fasting plasma glucose determiner 2600 may determine the virtual patient's fasting plasma glucose (FPG). This is described in more detail in FIG. 22 and the accompanying text. A virtual patient randomly measured blood glucose calculator 2602 coupled to the virtual patient fasting plasma glucose determiner 2600 may calculate the virtual patient's randomly measured blood glucose by solving the equation RPG(FPG)=(a+b/(1+exp(−(FPG−c)d)))*expΔ_{RPG}, wherein a, b, c, and d are constants, and Δ_{RPG} is an uncertainty value.

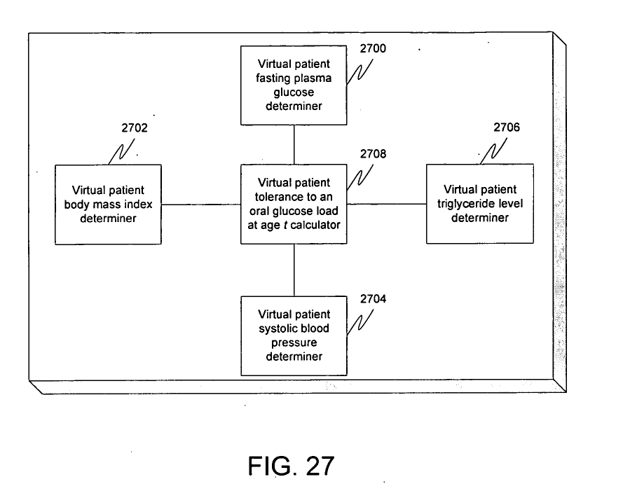

FIG. 27 is a block diagram illustrating an apparatus for estimating a virtual patient's tolerance to an oral glucose load at age t in accordance with an embodiment of the present invention. A virtual patient fasting plasma glucose determiner 2700 may determine the virtual patient's fasting plasma glucose (FPG). This is described in more detail in FIG. 22 and the accompanying text. A virtual patient body mass index determiner 2702 may determine the virtual patient's body mass index (BMI). A virtual patient systolic blood pressure determiner 2704 may determine the virtual patient's systolic blood pressure (SBP). Determining the virtual patient's SBP may include multiplying a peripheral resistance for the virtual patient by a diabetes blood pressure factor (DiabBP), which is a function of a diabetes feature and higher for people with more severe diabetes. A virtual patient triglyceride level determiner 2706 may determine the virtual patient's triglyceride level (TRI). A virtual patient tolerance to an oral glucose load at age t calculator 2708 coupled to the virtual patient fasting plasma glucose determiner 2700, the virtual patient body mass index determiner 2702, the virtual patient systolic blood pressure determiner 2704, and the virtual patient triglyceride level determiner 2706 may calculate the virtual patient's tolerance to an oral glucose load at age t by solving the equation:
OGT(t)=a*FPG(t)+bt+cBMI(t)+dSBP(t)+eTRI(t)−f+VAR_{OGT}.

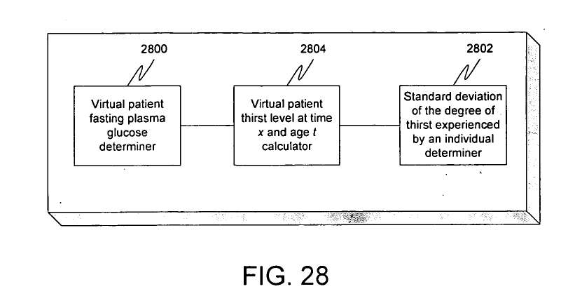

FIG. 28 is a block diagram illustrating an apparatus for estimating a virtual patient's thirst level at time x in accordance with an embodiment of the present invention. A virtual patient fasting plasma glucose determiner 2800 may determine the virtual patient's fasting plasma glucose (FPG). This is described in more detail in FIG. 22 and the accompanying text. A standard deviation of the degree of thirst experienced by an individual determiner 2802 may determine a standard deviation (SDₜₕᵢᵣₛₜ) of the degree of thirst experienced by an individual. A virtual patient thirst level at time x and age t calculator 2804 coupled to the virtual patient fasting plasma glucose determiner 2800 and to the standard deviation of the degree of thirst experienced by an individual determiner 2802 may calculate the virtual patient's thirst level at time x and age t by solving the equation

$$Thirst ( x , FPG ( t ) ) = \frac{1}{\sqrt{2 π {SD}_{thirst}}} exp ( - \\ ( \frac{x - {MeanSym}_{thirst} ( FPG ( t ) )}{2 {SD}_{thirst}} ) ) .$$

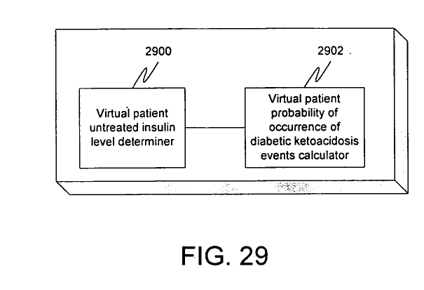

FIG. 29 is a block diagram illustrating an apparatus for estimating the probability of occurrence of diabetic ketoacidosis events (DKAₜᵢₘₑ) for a virtual patient in accordance with an embodiment of the present invention. A virtual patient untreated insulin level determiner 2900 may determine the virtual patient's insulin level if left untreated. A virtual patient probability of occurrence of diabetic ketoacidosis events calculator 2902 coupled to the virtual patient untreated insulin level determiner 2900 may calculate the virtual patient's probability of occurrence of diabetic ketoacidosis events by solving the equation DKAₜᵢₘₑ=Max(a/(1+exp(I_{untreated}−b)/c)d), wherein a, b, c, and d are constants.

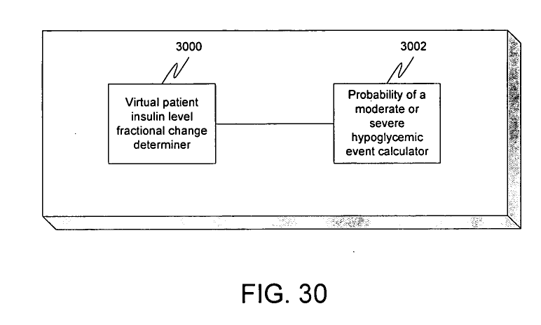

FIG. 30 is a block diagram illustrating an apparatus for estimating the probability of a moderate or severe hypoglycemic event (HypoGlyRate) in a virtual patient in accordance with an embodiment of the present invention. A virtual patient insulin level fractional change determiner 3000 may determine a fractional change in the insulin level of the virtual patient (FractΔᵢₙₛᵤₗᵢₙ). A probability of a moderate or severe hypoglycemic event calculator 3002 coupled to the virtual patient insulin level fractional change determiner 3000 may calculate the probability of a moderate or severe hypoglycemic event may be calculated by solving the equation
HypoGlyRate(FractΔᵢₙₛᵤₗᵢₙ)=a/(1+exp^{-(FractΔ}^{ᵢₙₛᵤₗᵢₙ}^{-b)tc}).

The present invention has significant advantages over the prior art. It is able to analyze guidelines, performance measures, the what-to-do parts of disease management programs, clinical priorities, medical necessity, and coverage policies, at the level of detail at which they are written, and at which clinicians debate these issues. Thus, the present invention is built at a fairly high level of biological detail, preserves the continuous nature of biological variables, and includes their interactions and feedback loops (homeostatic mechanisms). Second, timing issues may be easily addressed, such as how long to try one treatment before switching to another. The present invention also is able to address problems that range in pace from minute-to-minute to year-to-year.

The present invention also addresses problems relating to care processes, such as continuous quality improvement projects, the how-to-do-it parts of guidelines and disease management programs, and variations in practice patterns. The present invention therefore includes care processes at the level of detail at which these projects are conducted and evaluated. Furthermore, the effects of interventions on logistics, use of resources, costs, and cost-effectiveness are handled. This required inclusion of those variables, again at the level of detail at which people plan and make decisions.

The present invention also has the ability to address the interactions between diseases and comorbidities. To accomplish this, there is a single integrated model of biology from which all the diseases in the model arise, so that the important interactions can be realistically represented. Furthermore, to help set priorities and strategic goals, the present invention is able to span a wide range of interventions and a wide range of diseases.

The present invention is able to simulate clinical trials and other clinical experiences, which allows it to check the model and build credibility. All the important, clinical, and procedural factors that are part of a design of a trial, such as the inclusion criteria, treatment and testing protocols, biological outcomes, and health outcomes may all be handled at the level of detail at which they are actually defined in the trials.

The present invention may be used over and over to address a broad range of problems, and need not be retired. This is accomplished by being modeling physiology completely and naturally, without simply skipping over variables because they could be finessed for a particular question.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for estimating a virtual patient's fasting plasma glucose (FPG) level, comprising:
determining the virtual patient's basal hepatic production (FPG₀);
determining the virtual patient's insulin level (I); and
calculating the virtual patient's FPG at time t by solving the differential equation FPG(t)=FPG₀1(I*E), wherein E is a value representing efficiency of insulin use.

2. The method of claim 1, wherein E is scaled such that E=1 in the absence of diabetes and 0≦E≦1 in the presence of diabetes.

3. The method of claim 1, wherein for type 2 diabetes, a differential equation representing E is:
$$E ( {DF}_{2} ) = {( a + b / ( 1 + {( {DF}_{2} / c )}^{d} ) )}^{\frac{1}{2}} ,$$
wherein DF₂ is a type 2 diabetes feature.

4. The method of claim 3, wherein
$${DF}_{2} ( t ) = ( 1 - exp ( - a * IGT ( {ξ}_{3} ) / ( 1 + exp ( - \\ \frac{( t - b )}{c} ) ) ) ) * RBMI ( BMI ) / {ξ}_{2} ,$$
wherein a, b, and c are constants, IGT is an impaired glucose tolerance value, and RBMI is the relative risk associated with a person's body mass index (BMI).

5. The method of claim 4, wherein the RBMI is represented by:
RBMI(BMI)=a+b/(1+e^{-(BMI-c)/d}).

6. The method of claim 4, wherein IGT is represented by:
IGT(ξ₃)=2(1−ξ₃),
wherein ξ₃ is a random value designed to cause the occurrence of diabetes in virtual patients to have the same types of interpersonal variations that occur in real people.

7. The method of claim 1, wherein said determining said virtual patient's basal hepatic production in type 2 diabetes includes solving the differential equation
FPG₀(t)=G(t)*H(DF₂(t)),
wherein G(t) is the degree of insulin resistance in a person with diabetes (H).

8. The method of claim 7, wherein H(DF₂(t))=1(MAX[E²(DF₂(t+a)),b]).

9. The method of claim 7, wherein G(t)=(a+bt^{1.5}−c*t³+Δ_{g})/(d−eexp(−DF₂(t)ξ₂)), wherein Δ_{g} represents a variance of basal hepatic production across individuals.

10. The method of claim 1, wherein
I(DF₁,DF₂)=H(DF₂)*E(DF₂)/(1+exp((DF₁−a)/b)).

11. A method for estimating if a virtual patient has developed symptoms of type 1 diabetes, comprising:
representing the virtual patient's genetic propensity to develop type 1 diabetes by a family history value famhis;
determining if the virtual patient has developed symptoms of type 1 diabetes at time t by solving the differential equation DF₁(t)=(1−exp(−exp(a+bt+ct²+dt³+et⁴+ft⁵))*famhis)/ξ₁, wherein a, b, c, d, e, and f are constants and ξ₁ is a random value.

12. A method for estimating if a virtual patient has developed symptoms of type 2 diabetes, comprising:
determining the virtual patient's relative risk associated with body mass index (RBMI);
determining the virtual patient's impaired glucose tolerance level (IGT); and
determining if the virtual patient has developed symptoms of type 2 diabetes at time t by solving the differential equation
$${DF}_{2} ( t ) = ( 1 - exp ( - a * IGT ( {ξ}_{3} ) / ( 1 + exp ( - \\ \frac{( t - b )}{c} ) ) ) ) * RBMI ( BMI ) / {ξ}_{2} ,$$
wherein a, b, and c are constants.

13. The method of claim 12, wherein the RBMI is represented by: RBMI(BMI)=a+b/(1+e^{-(BMI-c)/d}), wherein BMI is the virtual patient's body mass index.

14. The method of claim 12, wherein IGT is represented by:
IGT(ξ₃)=2(1−ξ₃),
wherein ξ₃ is a random value.

15. A method for estimating a virtual patient's hemoglobin A_{1c}(HbA_{1c}), comprising:
determining said virtual patient's fasting plasma glucose (FPG); and
calculating said virtual patient's hemoglobin A_{1c} by solving the equation HbA_{1c}(FPG)=a*FPG−b, wherein a and b are constants.

16. A method for estimating a virtual patient's randomly measured blood glucose (RPG), comprising:
determining said virtual patient's fasting plasma glucose (FPG); and
calculating said virtual patient's randomly measured blood glucose by solving the equation RPG(FPG)=(a+b/(1+exp(−(FPG−c)d)))*expΔ_{RPG}, wherein a, b, c, and dare constants, and Δ_{RPG} is an uncertainty value.

17. A method for estimating a virtual patient's tolerance to an oral glucose load at age t, comprising:
determining the virtual patient's fasting plasma glucose (FPG);
determining the virtual patient's body mass index (BMI);
determining the virtual patient's systolic blood pressure (SBP);
determining the virtual patient's triglyceride level (TRI); and
calculating the virtual patient's tolerance to an oral glucose load at age t by solving the equation:
OGT(t)=a*FPG(t)+bt+cBMI(t)+dSBP(t)+eTRI(t)−f+VAR_{OGT}.

18. The method of claim 17, wherein said determining the virtual patient's SBP may include multiplying a peripheral resistance for the virtual patient by a diabetes blood pressure factor (DiabBP), which is a function of a diabetes feature and higher for people with more severe diabetes.

19. A method for estimating a virtual patient's thirst level at time x, comprising:
determining the virtual patient's fasting plasma glucose (FPG);
determining a standard deviation (SDₜₕᵢᵣₛₜ) of the degree of thirst experienced by an individual; and
calculating the virtual patient's thirst level at time x and age t by solving the equation
$$Thirst ( x , FPG ( t ) ) = \frac{1}{\sqrt{2 π {SD}_{thirst}}} exp ( - \\ ( \frac{x - {MeanSym}_{thirst} ( FPG ( t ) )}{2 {SD}_{thirst}} ) ) .$$

20. A method for estimating the probability of occurrence of diabetic ketoacidosis events (DKAₜᵢₘₑ) for a virtual patient, comprising:
determining the virtual patient's insulin level if left untreated; and
calculating the virtual patient's probability of occurrence of diabetic ketoacidosis events by solving the equation DKAₜᵢₘₑ=Max(a/(1+exp(I_{untreated}−b)/c)d), wherein a, b, c, and d are constants.

21. A method for estimating the probability of a moderate or severe hypoglycemic event (HypoGlyRate) in a virtual patient, comprising:
determining a fractional change in the insulin level of the virtual patient (FractΔᵢₙₛᵤₗᵢₙ); and
calculating the probability of a moderate or severe hypoglycemic event by solving the equation HypoGlyRate(FractΔᵢₙₛᵤₗᵢₙ)=a/(1+exp^{-(FractΔ}^{ᵢₙₛᵤₗᵢₙ}^{-b)tc}).

22. An apparatus for estimating a virtual patient's fasting plasma glucose (FPG) level, the apparatus comprising:
a virtual patient basal hepatic production determiner;
a virtual patient insulin level determiner; and
a virtual patient FPG level calculator coupled to said virtual patient basal hepatic production determiner and to said virtual patient insulin level determiner.

23. An apparatus for estimating if a virtual patient has developed symptoms of type 1 diabetes, the apparatus comprising:
a virtual patient genetic propensity to develop type 1 diabetes representer; and
a virtual patient type 1 diabetes determiner coupled to said virtual patient genetic propensity to develop type 1 diabetes representer.

24. An apparatus for estimating if a virtual patient has developed symptoms of type 2 diabetes, the apparatus comprising:
a virtual patient relative risk associated with body mass index determiner;
a virtual patient impaired glucose tolerance level determiner; and
a virtual patient type 2 diabetes determiner coupled to said virtual patient relative risk associated with body mass index determiner and to said virtual patient impaired glucose tolerance level determiner.

25. An apparatus for estimating a virtual patient's hemoglobin A_{1c}, the apparatus comprising:
a virtual patient fasting plasma glucose determiner; and
a virtual patient hemoglobin A_{1c} calculator coupled to said virtual patient fasting plasma glucose determiner.

26. An apparatus for estimating a virtual patient's randomly measured blood glucose, the apparatus comprising:
a virtual patient fasting plasma glucose determiner; and
a virtual patient randomly measured blood glucose calculator coupled to said virtual patient fasting plasma glucose determiner.

27. An apparatus for estimating a virtual patient's tolerance to an oral glucose load at age t, the apparatus comprising:
a virtual patient fasting plasma glucose determiner;
a virtual patient body mass index determiner;
a virtual patient systolic blood pressure determiner;
a virtual patient triglyceride level determiner; and
a virtual patient tolerance to an oral glucose load at age t calculator coupled to said virtual patient fasting plasma glucose determiner, said virtual patient body mass index determiner; said virtual patient systolic blood pressure determiner, and said virtual patient triglyceride level determiner.

28. An apparatus for estimating a virtual patient's thirst level at time x, the apparatus comprising:
a virtual patient fasting plasma glucose determiner;
a standard deviation of the degree of thirst experienced by an individual determiner; and
a virtual patient thirst level at time x and age t calculator coupled to said virtual patient fasting plasma glucose determiner and to said standard deviation of the degree of thirst experienced by an individual determiner.

29. An apparatus for estimating the probability of occurrence of diabetic ketoacidosis events for a virtual patient, the apparatus comprising:
a virtual patient untreated insulin level determiner; and
a virtual patient probability of occurrence of diabetic ketoacidosis events calculator coupled to said virtual patient untreated insulin level determiner.

30. An apparatus for estimating the probability of a moderate or severe hypoglycemic event in a virtual patient, the apparatus comprising:
a virtual patient insulin level fractional change determiner; and
a probability of a moderate or severe hypoglycemic event calculator coupled to said virtual patient insulin level fractional change determiner.

31. An apparatus for estimating a virtual patient's fasting plasma glucose (FPG) level, the apparatus comprising:
means for determining the virtual patient's basal hepatic production (FPG₀);
means for determining the virtual patient's insulin level (I); and
means for calculating the virtual patient's FPG at time t by solving the differential equation FPG(t)=FPG₀/(I*E), wherein E is a value representing efficiency of insulin use.

32. The apparatus of claim 31, wherein E is scaled such that E=1 in the absence of diabetes and 0≦E≦1 in the presence of diabetes.

33. The apparatus of claim 31, wherein for type 2 diabetes, a differential equation representing E is:
$$E ( {DF}_{2} ) = {( a + b / ( 1 + {( {DF}_{2} / c )}^{d} ) )}^{\frac{1}{2}} ,$$
wherein DF₂ is a type 2 diabetes feature.

34. The apparatus of claim 33, wherein
$${DF}_{2} ( t ) = ( 1 - exp ( - a * IGT ( {ξ}_{3} ) / ( 1 + exp ( - \\ \frac{( t - b )}{c} ) ) ) ) * RBMI ( BMI ) / {ξ}_{2} ,$$
wherein a, b, and c are constants, IGT is an impaired glucose tolerance value, and RBMI is the relative risk associated with a person's body mass index (BMI).

35. The apparatus of claim 33, wherein the RBMI is represented by:
RBMI_{Women}(BMI)=a+b/(1+e^{-(BMI-c)/d}).

36. The apparatus of claim 33, wherein IGT is represented by:
IGT(ξ₃)=2(1−ξ₃),
wherein ξ₃ is a random value designed to cause the occurrence of diabetes in virtual patients to have the same types of interpersonal variations that occur in real people.

37. The apparatus of claim 31, wherein said means for determining said virtual patient's basal hepatic production in type 2 diabetes includes means for solving the differential equation FPG₀(t)=G(t)*H(DF₂(t)), wherein G(t) is the degree of insulin resistance in a person with diabetes (H).

38. The apparatus of claim 37, wherein H(DF₂(t))=1/(MAX [E²(DF₂(t+a)), b]).

39. The apparatus of claim 37, wherein G(t)=(a+bt^{1.5}−C*t³+Δ_{g})/(d−e exp(−DF₂(t)ξ₂)), wherein Δ_{g} represents a variance of basal hepatic production across individuals.

40. The apparatus of claim 31, wherein
I(DF₁,DF₂)=H(DF₂)*E(DF₂)/(1+exp((DF₁−a)/b)).

41. An apparatus for estimating if a virtual patient has developed symptoms of type 1 diabetes, the apparatus comprising:
means for representing the virtual patient's genetic propensity to develop type 1 diabetes by a family history value famhis;
means for determining if the virtual patient has developed symptoms of type 1 diabetes at time t by solving the differential equation DF₁(t)=(1−exp(−exp(a+bt+ct²+dt³+et⁴+ft⁵))*famhis)/ξ₁, wherein a, b, c, d, e, and f are constants and ξ₁ is a random value.

42. An apparatus for estimating if a virtual patient has developed symptoms of type 2 diabetes, the apparatus comprising:
means for determining the virtual patient's relative risk associated with body mass index (RBMI);
means for determining the virtual patient's impaired glucose tolerance level (IGT); and
means for determining if the virtual patient has developed symptoms of type 2 diabetes at time t by solving the differential equation
$${DF}_{2} ( t ) = ( 1 - exp ( - a * IGT ( {ξ}_{3} ) / ( 1 + exp ( - \\ \frac{( t - b )}{c} ) ) ) ) * RBMI ( BMI ) / {ξ}_{2} ,$$
wherein a, b, and c are constants.

43. The apparatus of claim 42, wherein the RBMI is represented by: RBMI(BMI)=a+b/(1+e^{-(BMI-c)/d}), wherein BMI is the virtual patient's body mass index.

44. The apparatus of claim 42, wherein IGT is represented by:
IGT(ξ₃)=2(1−ξ₃),
wherein ξ₃ is a random value.

45. An apparatus for estimating a virtual patient's hemoglobin A_{1c} (HbA_{1c}), comprising:
means for determining said virtual patient's fasting plasma glucose (FPG); and
means for calculating said virtual patient's hemoglobin A_{1c} by solving the equation HbA_{1c}(FPG)=a*FPG−b, wherein a and b are constants.

46. An apparatus for estimating a virtual patient's randomly measured blood glucose (RPG), the apparatus comprising:
means for determining said virtual patient's fasting plasma glucose (FPG); and
means for calculating said virtual patient's randomly measured blood glucose by solving the equation RPG(FPG)=(a+b/(1+exp(−(FPG−c)d)))*expΔ_{RPG}, wherein a, b, c, and d are constants, and Δ_{RPG} is an uncertainty value.

47. An apparatus for estimating a virtual patient's tolerance to an oral glucose load at age t, comprising:
means for determining the virtual patient's fasting plasma glucose (FPG);
means for determining the virtual patient's body mass index (BMI);
means for determining the virtual patient's systolic blood pressure (SBP);
means for determining the virtual patient's triglyceride level (TRI); and
means for calculating the virtual patient's tolerance to an oral glucose load at age t by solving the equation:
OGT(t)=a*FPG(t)+bt+cBMI(t)+dSBP(t)+eTRI(t)−f+VAR_{OGT}

48. The apparatus of claim 47, wherein said means for determining the virtual patient's SBP may include means for multiplying a peripheral resistance for the virtual patient by a diabetes blood pressure factor (DiabBP), which is a function of a diabetes feature and higher for people with more severe diabetes.

49. An apparatus for estimating a virtual patient's thirst level at time x, the apparatus comprising:
means for determining the virtual patient's fasting plasma glucose (FPG);
means for determining a standard deviation (SDₜₕᵢᵣₛₜ) of the degree of thirst experienced by an individual; and
means for calculating the virtual patient's thirst level at time x and age t by solving the equation
$$Thirst ( x , FPG ( t ) ) = \frac{1}{\sqrt{2 π {SD}_{thirst}}} exp ( - \\ ( \frac{x - {MeanSym}_{thirst} ( FPG ( t ) )}{2 {SD}_{thirst}} ) ) .$$

50. An apparatus for estimating the probability of occurrence of diabetic ketoacidosis events (DKAₜᵢₘₑ) for a virtual patient, comprising:
means for determining the virtual patient's insulin level if left untreated; and
means for calculating the virtual patient's probability of occurrence of diabetic ketoacidosis events by solving the equation DKAₜᵢₘₑ=Max(a/(1+exp(I_{untreated}−b)/c)d), wherein a, b, c, and d are constants.

51. An apparatus for estimating the probability of a moderate or severe hypoglycemic event (HypoGlyRate) in a virtual patient, comprising:
means for determining a fractional change in the insulin level of the virtual patient (FractΔᵢₙₛᵤₗᵢₙ); and
means for calculating the probability of a moderate or severe hypoglycemic event by solving the equation HypoGlyRate(FractΔᵢₙₛᵤₗᵢₙ)=a/(1+exp^{-(FractΔ}^{ᵢₙₛᵤₗᵢₙ}^{-b)/c}).

52. A program storage device readable by a machine, tangibly embodying a program of instructions executable by the machine to perform a method for estimating a virtual patient's fasting plasma glucose (FPG) level, the method comprising:
determining the virtual patient's basal hepatic production (FPG₀);
determining the virtual patient's insulin level (I); and
calculating the virtual patient's FPG at time t by solving the differential equation FPG(t)=FPG₀/(I*E), wherein E is a value representing efficiency of insulin use.

53. A program storage device readable by a machine, tangibly embodying a program of instructions executable by the machine to perform a method for estimating if a virtual patient has developed symptoms of type 1 diabetes, the method comprising:
representing the virtual patient's genetic propensity to develop type 1 diabetes by a family history value famhis;
determining if the virtual patient has developed symptoms of type 1 diabetes at time t by solving the differential equation DF₁(t)=(1-exp(−exp(a+bt+Ct²+dt³+et⁴+ft⁵))*famhis)/ν₁, wherein a, b, c, d, e, and f are constants and ξ₁ is a random value.

54. A program storage device readable by a machine, tangibly embodying a program of instructions executable by the machine to perform a method for estimating if a virtual patient has developed symptoms of type 2 diabetes, the method comprising:
determining the virtual patient's relative risk associated with body mass index (RBMI);
determining the virtual patient's impaired glucose tolerance level (IGT); and
determining if the virtual patient has developed symptoms of type 2 diabetes at time t by solving the differential equation
$${DF}_{2} ( t ) = ( 1 - exp ( - a * IGT ( {ξ}_{3} ) / ( 1 + exp ( - \\ \frac{( t - b )}{c} ) ) ) ) * RBMI ( BMI ) / {ξ}_{2} ,$$
wherein a, b, and c are constants.

55. A program storage device readable by a machine, tangibly embodying a program of instructions executable by the machine to perform a method for estimating a virtual patient's hemoglobin A_{1c}(HbA_{1c}), the method comprising:
determining said virtual patient's fasting plasma glucose (FPG); and
calculating said virtual patient's hemoglobin A_{1c} by solving the equation HbA_{1c}(FPG)=a*FPG−b, wherein a and b are constants.

56. A program storage device readable by a machine, tangibly embodying a program of instructions executable by the machine to perform a method for estimating a virtual patient's randomly measured blood glucose (RPG), the method comprising:
determining said virtual patient's fasting plasma glucose (FPG); and
calculating said virtual patient's randomly measured blood glucose by solving the equation RPG(FPG)=(a+b/(1+exp(−(FPG−c)d)))*expΔ_{RPG}, wherein a, b, c, and d are constants, and Δ_{RPG} is an uncertainty value.

57. A program storage device readable by a machine, tangibly embodying a program of instructions executable by the machine to perform a method for estimating a virtual patient's tolerance to an oral glucose load at age t, the method comprising:
determining the virtual patient's fasting plasma glucose (FPG);
determining the virtual patient's body mass index (BMI);
determining the virtual patient's systolic blood pressure (SBP);
determining the virtual patient's triglyceride level (TRI); and
calculating the virtual patient's tolerance to an oral glucose load at age t by solving the equation:
OGT(t)=a*FPG(t)+bt+cBMI(t)+dSBP(t)+eTRI(t)−f+VAR_{OGT}

58. A program storage device readable by a machine, tangibly embodying a program of instructions executable by the machine to perform a method for estimating a virtual patient's thirst level at time x, the method comprising:
determining the virtual patient's fasting plasma glucose (FPG);
determining a standard deviation (SDₜₕᵢᵣₛₜ) of the degree of thirst experienced by an individual; and
calculating the virtual patient's thirst level at time x and age t by solving the equation
$$\begin{matrix}Thirst ( x , \\ FPG ( t ) )\end{matrix} = \frac{1}{\sqrt{2 π {SD}_{thirst}}} exp ( - ( \frac{x - {MeanSym}_{thirst} ( FPG ( t ) )}{2 {SD}_{thirst}} ) ) .$$

59. A program storage device readable by a machine, tangibly embodying a program of instructions executable by the machine to perform a method for estimating the probability of occurrence of diabetic ketoacidosis events (DKAₜᵢₘₑ) for a virtual patient, the method comprising:
determining the virtual patient's insulin level if left untreated; and
calculating the virtual patient's probability of occurrence of diabetic ketoacidosis events by solving the equation DKAₜᵢₘₑ=Max(a/(1+exp(I_{untreated}−b)/c)d), wherein a, b, c, and d are constants.

60. A program storage device readable by a machine, tangibly embodying a program of instructions executable by the machine to perform a method for estimating the probability of a moderate or severe hypoglycemic event (HypoGlyRate) in a virtual patient, the method comprising:
determining a fractional change in the insulin level of the virtual patient (FractΔᵢₙₛᵤₗᵢₙ); and
calculating the probability of a moderate or severe hypoglycemic event by solving the equation HypoGlyRate(FractΔᵢₙₛᵤₗᵢₙ)=a/(1+exp^{-(FractΔ}^{ᵢₙₛᵤₗᵢₙ}^{-b)tc}).
